(19) United States
(12) Patent Application Publication
(10) Pub. No.: US 2025/0175478 A1
(43) Pub. Date: May 29, 2025

(54) UNIVERSAL INTRUSION DETECTION AND PREVENTION FOR VEHICLE NETWORKS

(71) Applicant: Sonatus, Inc., Sunnyvale, CA (US)

(72) Inventors: Yu Fang, Palo Alto, CA (US); Andrew Ling, Daly City, CA (US); Felipe Andres Valdes Valenzuela, Mountain View, CA (US); Xuanran Zong, Sunnyvale, CA (US); Sudhir Ramphal Dhankhar, Dublin, CA (US); Chai Fangming, San Jose, CA (US)

(21) Appl. No.: 19/037,617

(22) Filed: Jan. 27, 2025

Related U.S. Application Data
(63) Continuation of application No. 18/235,481, filed on Aug. 18, 2023.
Application No. 18/235,481 is a continuation of application No. PCT/US2022/046292, filed on Oct. 11, 2022.
Application No. PCT/US2022/046292 is a continuation-in-part of application No. 17/195,589, filed on Mar. 8, 2021, now Pat. No. 11,538,287.
(60) Provisional application No. 63/253,950, filed on Oct. 8, 2021.
(60) Provisional application No. 62/986,444, filed on Mar. 6, 2020.
(60) Provisional application No. 63/024,383, filed on May 13, 2020.
(60) Provisional application No. 63/123,531, filed on Dec. 10, 2020.

(51) Int. Cl. H04L 9/40; H04L 67/75

(52) U.S. Cl. CPC H04L 63/1416; H04L 63/1425; H04L 67/75

(57) ABSTRACT

A device may include a vehicle comprising a plurality of network zones, each network zone comprising a plurality of end points. A device may include a controller, comprising: a log monitoring component configured to interpret a log corpus associated with at least one of the plurality of end points, a log analysis component configured to detect a risk event in response to the log corpus, and a risk response component configured to perform a risk response operation in response to the detected risk event.

### CROSS-REFERENCE TO RELATED APPLICATIONS

The present application is a continuation of, and claims priority to, U.S. patent application Ser. No. 18/235,481, filed Aug. 18, 2023, published as US 2023-0396634 A1 on Dec. 7, 2023, and entitled “UNIVERSAL INTRUSION DETECTION AND PREVENTION FOR VEHICLE NETWORKS” (SONA-0013-U01).

U.S. patent application Ser. No. 18/235,481, filed Aug. 18, 2023, is a continuation of, and claims priority to, PCT Patent Application Serial No. PCT/US2022/046292, filed on Oct. 11, 2022, published on Apr. 13, 2023, as WIPO publication No. WO 2023/059938 and entitled “UNIVERSAL INTRUSION DETECTION AND PREVENTION FOR VEHICLE NETWORKS” (SONA-0013-WO).

PCT Patent Application Serial No. PCT/US2022/046292 claims the benefit of U.S. Provisional Patent Application Ser. No. 63/253,950, filed on Oct. 8, 2021 and entitled “UNIVERSAL INTRUSION DETECTION AND PREVENTION FOR A VEHICLE” (SONA-0013-P01).

PCT Patent Application Serial No. PCT/US2022/046292 is a continuation-in-part of, and claims priority to, U.S. patent application Ser. No. 17/195,589, filed on Mar. 8, 2021 and entitled “SYSTEM, METHOD, AND APPARATUS FOR MANAGING VEHICLE DATA COLLECTION” (SONA-0010-U01), now U.S. Pat. No. 11,538,287 issued Dec. 27, 2022.

U.S. patent application Ser. No. 17/195,589 claims the benefit of the following U.S. Provisional Patent Applications: U.S. Provisional Patent Application Ser. No. 62/986,444, filed Mar. 6, 2020 and entitled “SYSTEM, METHOD AND APPARATUS FOR IMPLEMENTING CONFIGURABLE DATA COLLECTION FOR A VEHICLE” (SONA-0004-P01); U.S. Provisional Patent Application Ser. No. 63/024,383, filed May 13, 2020 and entitled “SYSTEM, METHOD AND APPARATUS TO TEST AND VERIFY A VEHICLE NETWORK” (SONA-0005-P01); and U.S. Provisional Patent Application Ser. No. 63/123,531, filed Dec. 10, 2020 and entitled “SYSTEM, METHOD AND APPARATUS FOR ENHANCING VEHICLE COMMUNICATIONS AND OPERATIONS” (SONA-0009-P01).

All of the foregoing listed patent applications and patents are incorporated herein by reference in their entirety for all purposes.

### BACKGROUND

Mobile applications, such as vehicles, are being developed with increasing connectivity to the environment outside of the mobile application itself, for example to enable entertainment access, for various consumer support features, to support vehicle servicing operations, or the like. The increasing number of connections introduce risks from malware, ransomware, disruptive communications, intrusive communications, 3^{rd} party access to sensitive information, and/or introduce risks to control of the mobile application itself. Improper access to the mobile application can result in degradation or loss of the mobile application to perform the mission, for example due to loss or degradation of network utilization (e.g., due to significant improper traffic), spoofing, changing, and/or surveying control signals, installation of tracking or malware on electronic control units (ECUs) of the mobile application, or the like. At the same time, the number of computing devices and/or networks present on the mobile application is also increasing, multiplying the risk points, increasing the difficulty in detecting and managing improper access, and/or increasing the negative consequences of improper access, as a greater number of systems of the mobile application are exposed to network traffic, and as a greater amount of sensitive information is exposed to improper access.

### SUMMARY

Example embodiments herein are capable to manage, prevent, block, and/or mitigate improper communications to a mobile application, such as a vehicle. Embodiments herein are capable to maintain visibility and control of all end points on multiple networks, including networks of varying types, protocols, etc. Additionally or alternatively, improper communications may be sent to a cloud server supporting the mobile application, for example from a compromised ECU on the mobile application, and such improper communications can be managed, prevented, blocked, and/or mitigated by embodiments herein. Intrusions as utilized herein should be understood broadly, and include any communications that are not a part of proper operation of the mobile application, including malicious communications (e.g., attempts to access data, interfere with operations of a network and/or end point, attempts to spoof data and/or replace data, attempts to install malware of any type, or the like), erroneous communications (e.g., communications erroneously addressed to an improper location and/or being sent at an erroneous rate), and/or off nominal communications sent due to a failure (e.g., corrupted data resulting in improper addressing of communications, communications sent by a failed device such as a damaged sensor or ECU, etc.). Intrusion detection and prevention as set forth herein is universal, at least in certain embodiments, as the operations are capable to protect all end points on all networks of the mobile application, as well as related components (e.g., supporting operations on a cloud server), regardless of the number and type of networks present, the distribution of operations on-vehicle and off-vehicle, the source of intrusive communications (e.g., on-vehicle or off-vehicle), or the target of intrusive communications (e.g., on-vehicle, off-vehicle, on a cloud server, and/or a connected device such as a service tool, manufacturing tool, engineering tool, or the like).

Embodiments herein provide convenient levers for persons related to the mobile application, such as a security or compliance officer, service personnel, mobile application owner and/or operator, and/or an administrator of any type (e.g., an outsourced security company) to monitor any number of mobile applications (e.g., vehicles) for improper access events, to adjust detection criteria for events, to respond rapidly to events to protect mobile applications from improper access, and/or to adjust prevention, detection, and/or mitigation responses for improper access and/or attempts. Embodiments herein allow for detection of improper access and/or attempts to be based upon a number of mobile applications, for example a related group of vehicles, to improve detection (e.g., where the data from a number of vehicles identifies the attempt(s) more quickly than data from a single vehicle would allow for) and/or to improve prevention of improper access (e.g., where a related group of vehicles, vehicles have a specific feature, vehicles having a specific network type, etc., are being subjected to an attack, embodiments herein allow for relevant vehicles to be protected before they have actually been attacked).

Embodiments herein allow for automated responses to improper access attacks, for example by performing automated responses when such attacks are detected or suspected, allowing for relevant personnel to roll out automated responses to specified mobile applications and/or vehicles, for example developed after the attack has been identified and/or characterized, where those automated responses can be implemented without a software or firmware update to the vehicle, which inconveniences the vehicle owner/operator, increases the cost of updates, increases the potential for a failure of the update (e.g., by bricking a relevant ECU during the update process), and/or increases the time between development of the automated response and implementation on vehicles, thereby increasing the risk and potential damage caused by the improper access event.

In certain embodiments, automated responses to one or more types of attacks may be pre-installed on the mobile application, ready for implementation when an attack is detected or suspected. Automated responses may include blocking certain source addresses and/or destination addresses, adjusting network traffic on the vehicle (e.g., moving control operations between ECUs, re-routing traffic on the vehicle, enabling or disabling services such as data publication or storage services), adjusting data life cycle values (e.g., storing and/or retaining data, for example data relevant to the suspected attack, that would otherwise not be stored or retained, and/or storing a dedicated log of data, potentially as set forth in the automated response, that may be used to identify, characterize, and/or confirm the potential improper access or attack). Automated responses may include adjusting detection criteria (e.g., changing event detection parameters to be more sensitive or less sensitive, turning on heuristic or expert system detection parameters, etc.), and/or providing an alert or notification (e.g., to an external device such as a cloud server, service personnel or device, security personnel or device, etc.; and/or to an internal device such as a cloud communication manager, network manager, security manager, etc.) based on the detected attack or attempt. In certain embodiments, alerts and/or notifications may be provided from an external device to the mobile application, for example where an improper access event is detected in a component running on a cloud server, for example operating enhanced processing on network data and/or operating improved detection operations utilizing data from a number of mobile applications together, where the alert and/or notification is sent to an internal device such as a cloud communication manager, network manager, security manager, etc.

Embodiments herein allow for monitoring and/or analysis of a log to detect one or more of various anomalous conditions, including conditions that may affect security (e.g., intrusive access or communications), the mobile application mission (e.g., ability to perform as intended, which may be at risk due to network degradation, message interference, improper access to an ECU or other end point, etc.), and/or safe operation of the mobile application (e.g., due to interference with operator control, disabling of expected features, changing settings, improper tracking of sensitive information such as locations, etc.). Embodiments herein provide for a number of improvements to servicing for mobile applications utilizing monitoring and/or analysis of a log, for example: detecting anomalous conditions before a formal fault code is logged; providing for notifications to external devices for anomalous conditions (e.g., to improve response times, allow for a service person or fleet manager to schedule service and/or ensure parts are ready, etc.); allowing for enhanced diagnostic operations in response to anomalous conditions, including diagnostic operations that are transparent to the operator, and/or that do not require a shutdown of the mobile application, and/or an update to software or firmware for an ECU on the mobile application; allowing for detection of anomalous conditions using data from multiple related vehicles, allowing for earlier detection and higher confidence detection; and/or allowing for the data to be included in the log to be adjusted, without interference with operations of the vehicle, to enhance detection, confirmation, and/or confidence levels, for anomalous conditions.

### BRIEF DESCRIPTION

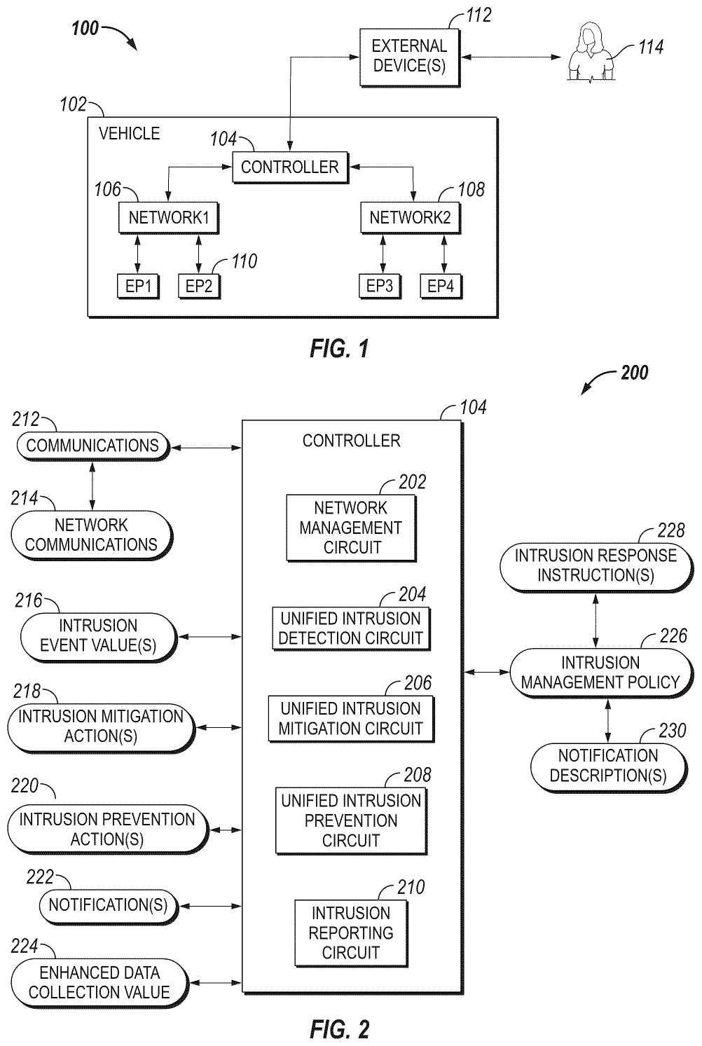

FIG. 1 is a schematic diagram of an example communication system for a mobile system, according to certain embodiments of the present disclosure;

FIG. 2 is a schematic diagram for a network management controller, according to certain embodiments of the present disclosure;

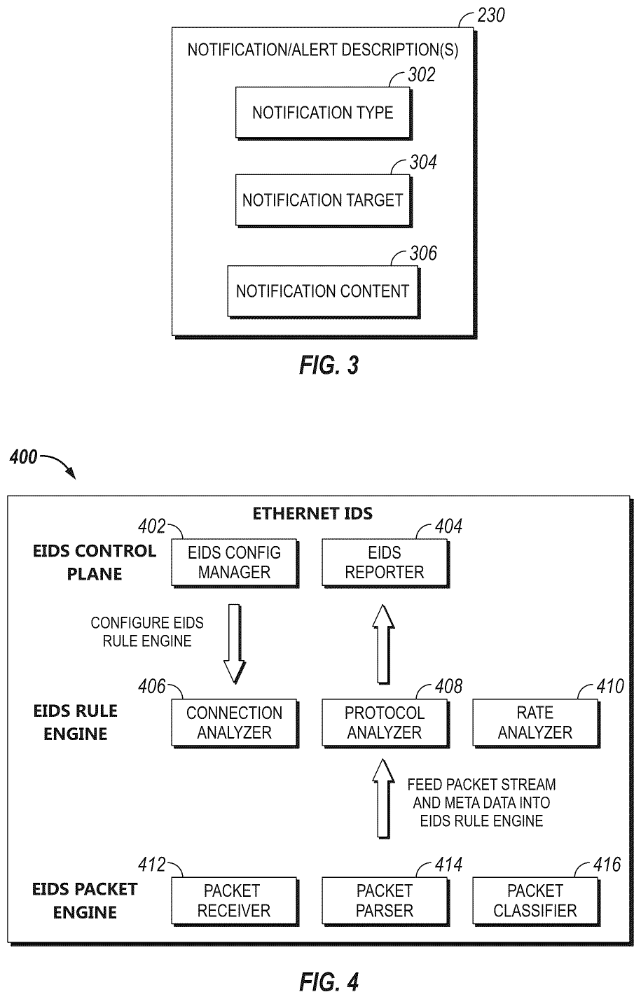

FIG. 3 is a block diagram depicting a notification, according to certain embodiments of the present disclosure;

FIG. 4 is a schematic diagram of an ethernet IDS, according to certain embodiments of the present disclosure;

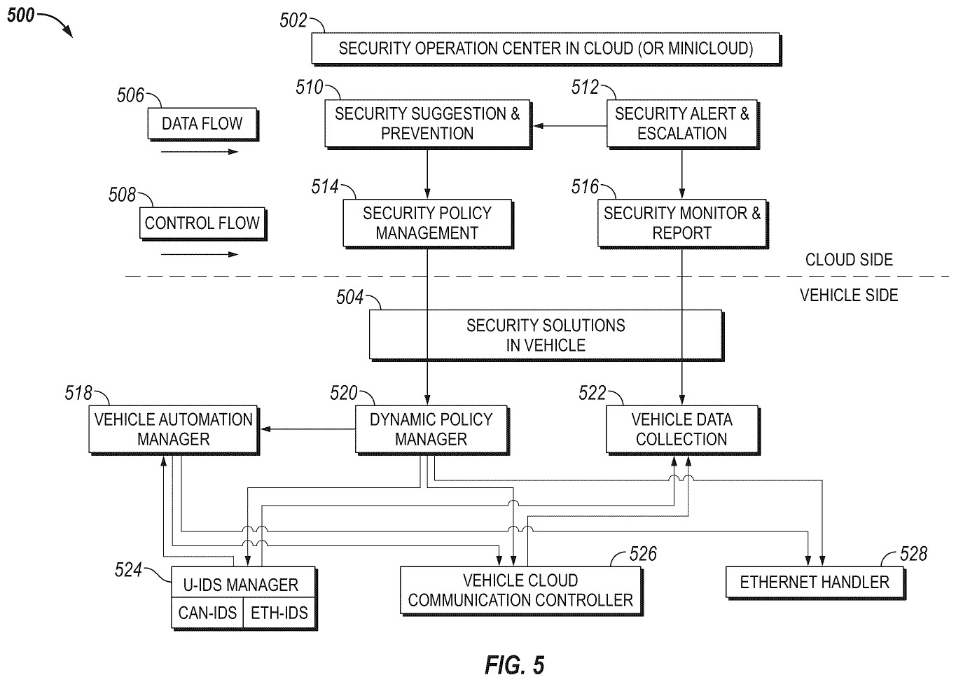

FIG. 5 is a block diagram depicting a cloud-side IDS and a mobile system-side IDS of the communication system for the mobile system of FIG. 1, according to certain embodiments of the present disclosure;

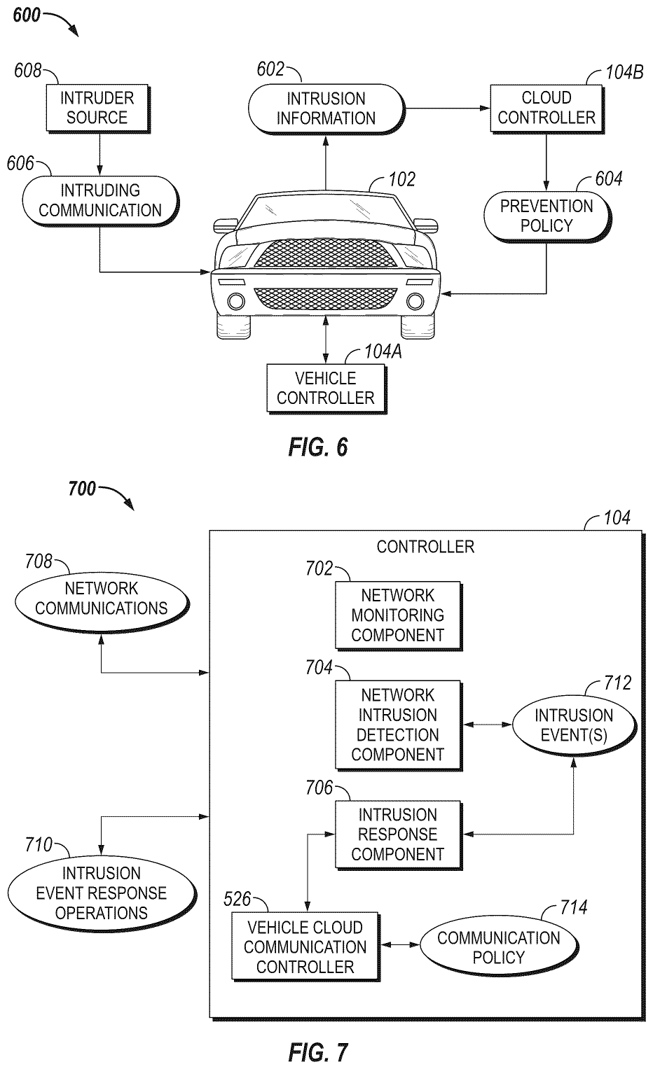

FIG. 6 is a schematic diagram of a mobile system having an ethernet IDS, according to certain embodiments of the present disclosure;

FIG. 7 is a schematic diagram of controller for on-vehicle intrusion detection, according to certain embodiments of the present disclosure;

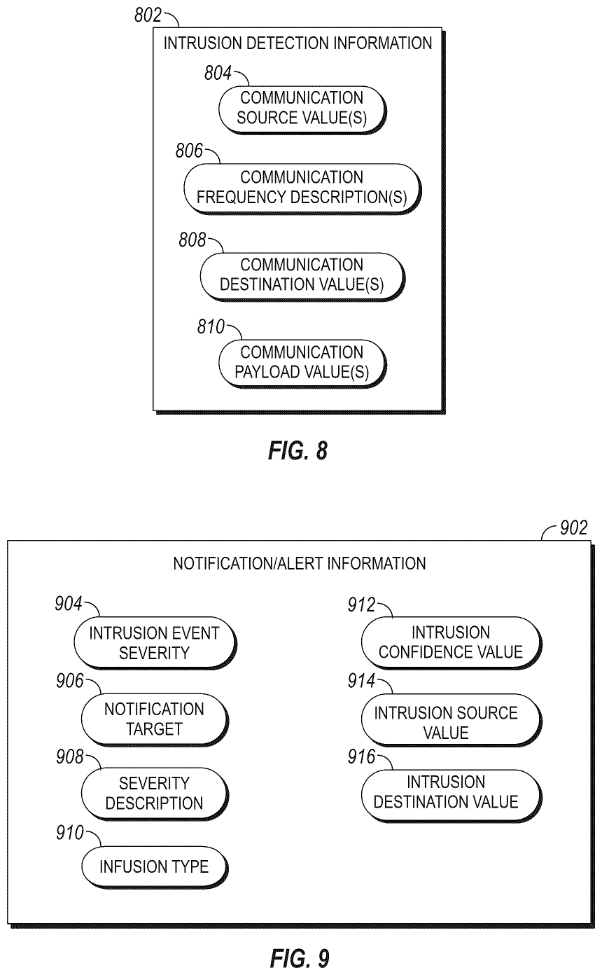

FIG. 8 is a block diagram depicting intrusion detection information, according to certain embodiments of the present disclosure;

FIG. 9 is another block diagram depicting a notification, according to certain embodiments of the present disclosure;

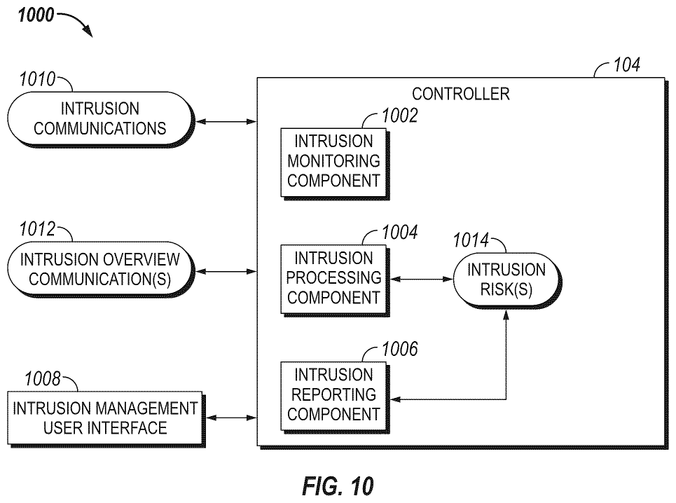

FIG. 10 is a schematic diagram of a controller for cloud-based monitoring and analysis of intrusion detection information, according to certain embodiments of the present disclosure;

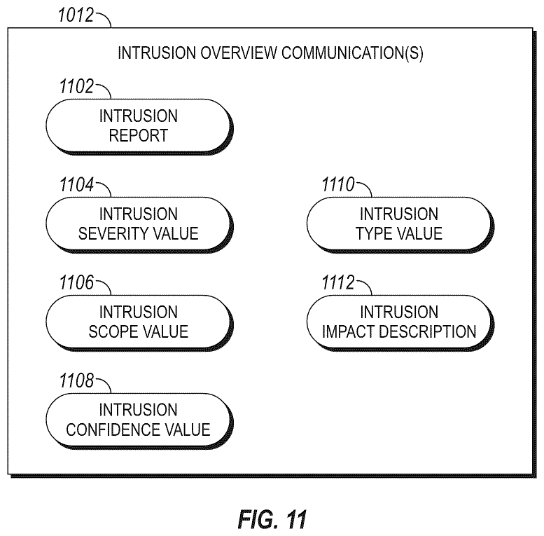

FIG. 11 is a block diagram of an intrusion overview communication, according to certain embodiments of the present disclosure;

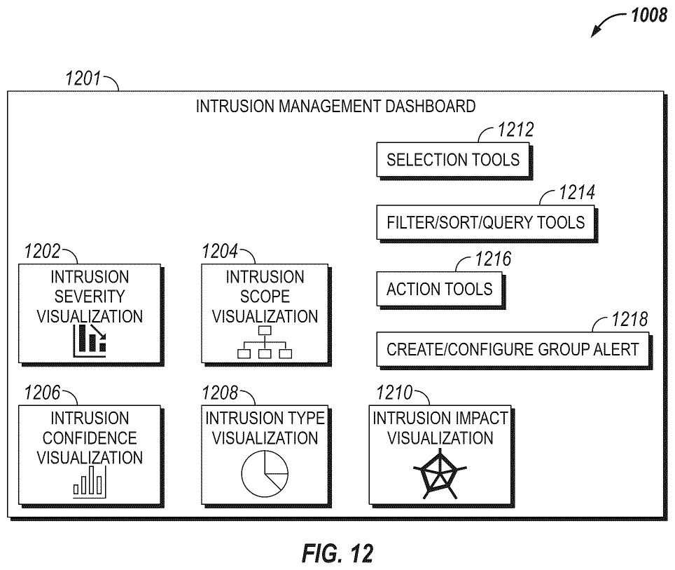

FIG. 12 is a schematic diagram of an intrusion management dashboard, according to certain embodiments of the present disclosure;

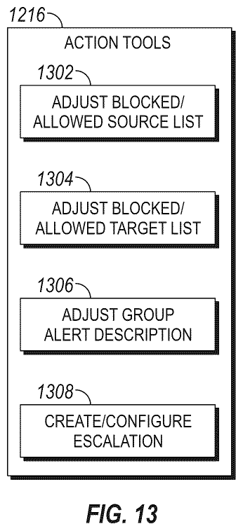

FIG. 13 is a block diagram of action tools, according to certain embodiments of the present disclosure;

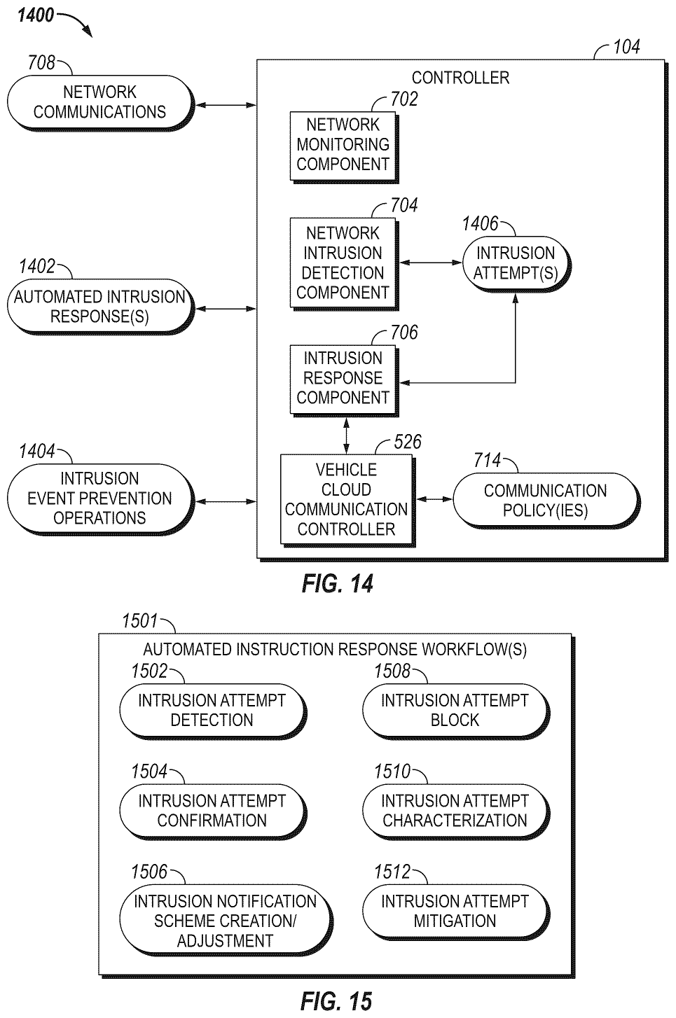

FIG. 14 is a schematic diagram of controller for intrusion prevention operations, according to certain embodiments of the present disclosure;

FIG. 15 is a block diagram of an automated intrusion response workflow, according to certain embodiments of the present disclosure;

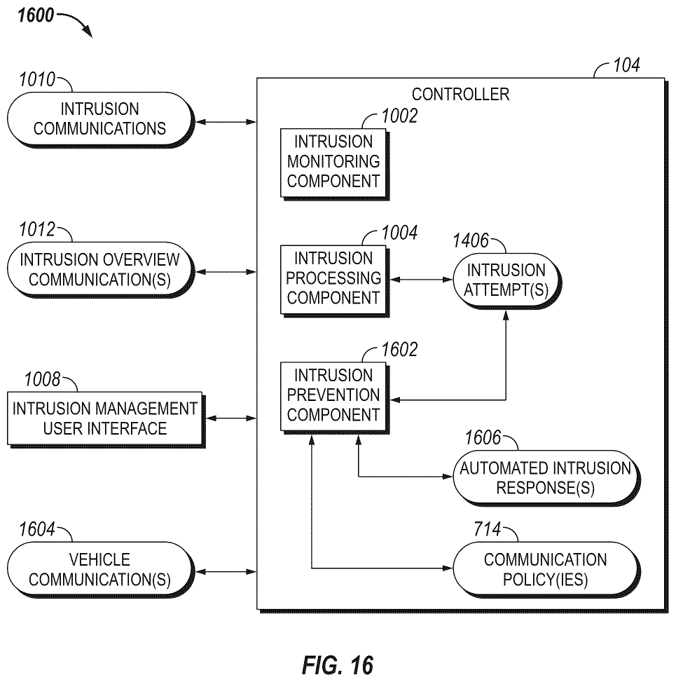

FIG. 16 is a schematic diagram of another controller for intrusion prevention operations, according to certain embodiments of the present disclosure;

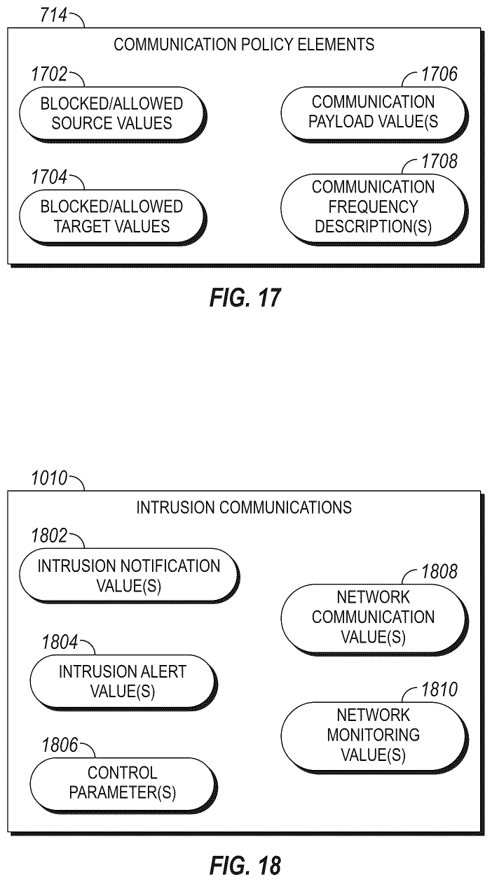

FIG. 17 is a block diagram depicting communication policy elements, according to certain embodiments of the present disclosure;

FIG. 18 is a block diagram depicting intrusion communications, according to certain embodiments of the present disclosure;

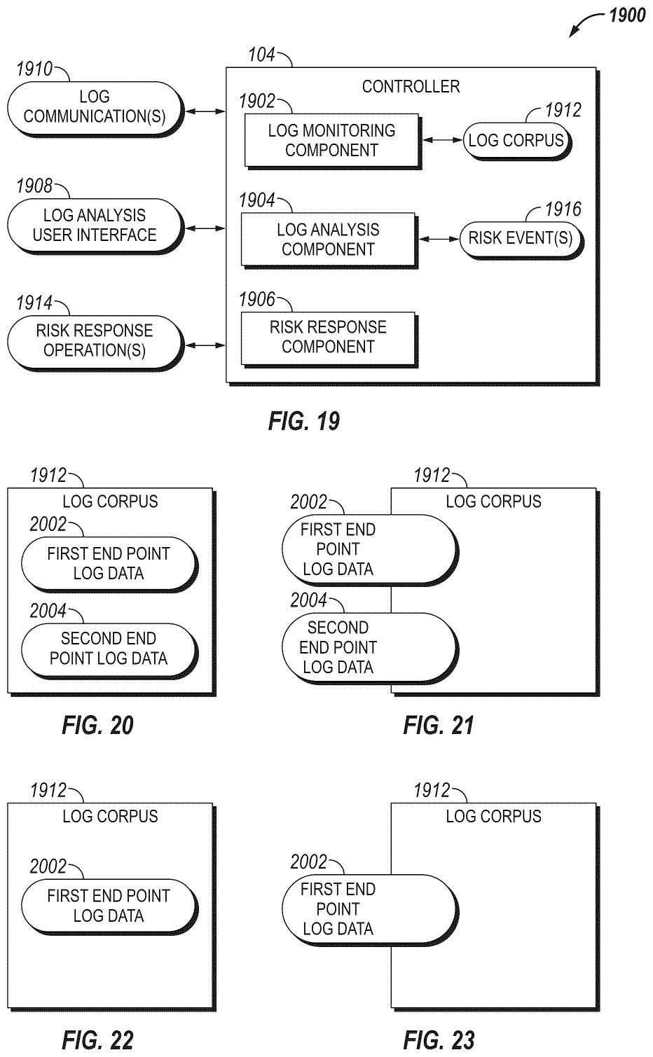

FIG. 19 is a schematic diagram of a controller for monitoring and analyzing logs, according to certain embodiments of the present disclosure;

FIG. 20 is a block diagram depicting a log corpus, according to certain embodiments of the present disclosure;

FIG. 21 is another block diagram depicting the log corpus of FIG. 20, according to certain embodiments of the present disclosure;

FIG. 22 is another block diagram depicting the log corpus of FIG. 20, according to certain embodiments of the present disclosure;

FIG. 23 is another block diagram depicting the log corpus of FIG. 20, according to certain embodiments of the present disclosure;

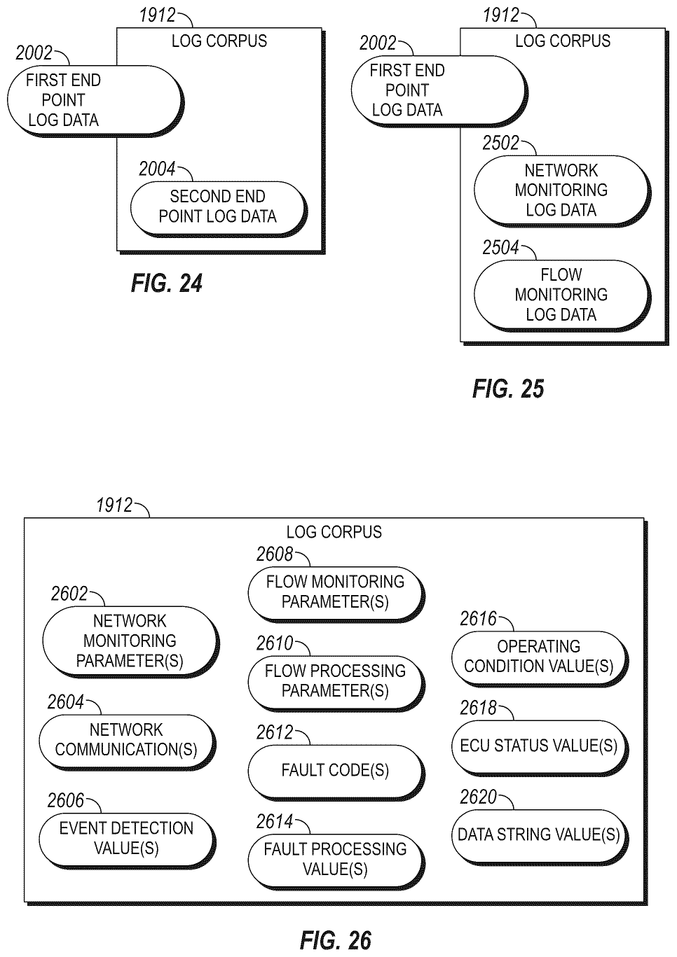

FIG. 24 is another block diagram depicting the log corpus of FIG. 20, according to certain embodiments of the present disclosure;

FIG. 25 is another block diagram depicting the log corpus of FIG. 20, according to certain embodiments of the present disclosure;

FIG. 26 is another block diagram depicting the log corpus of FIG. 20, according to certain embodiments of the present disclosure;

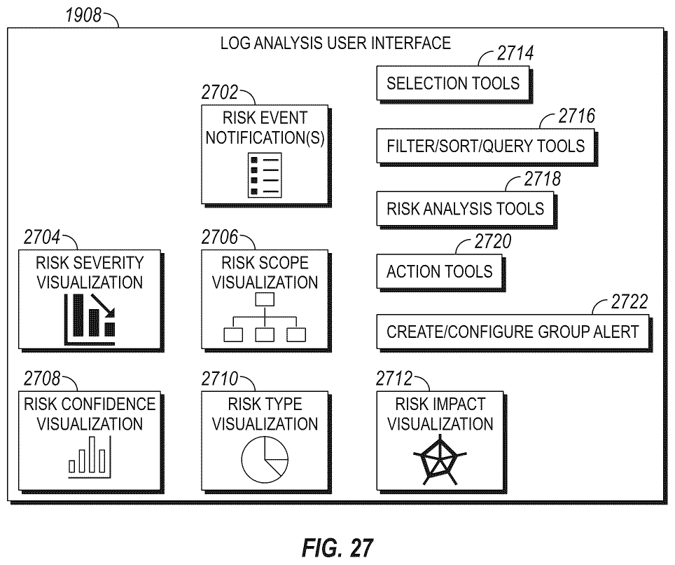

FIG. 27 is a schematic diagram of a log analysis user interface, according to certain embodiments of the present disclosure;

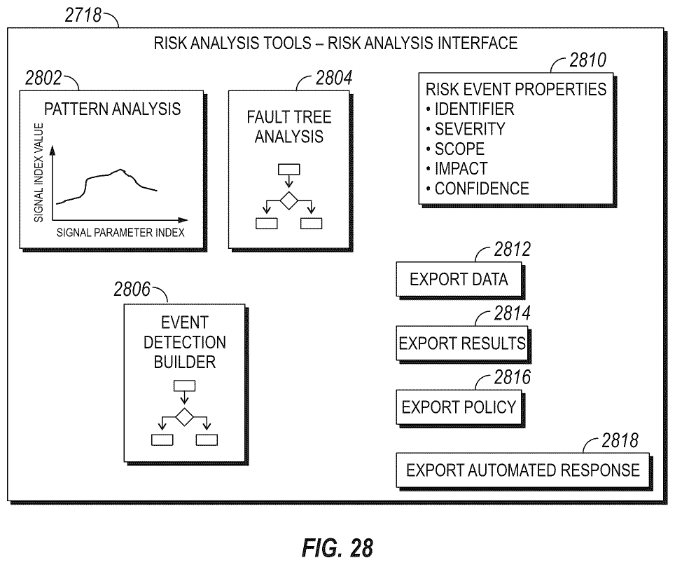

FIG. 28 is a schematic diagram of a fault analysis interface of a risk analysis tool, according to certain embodiments of the present disclosure;

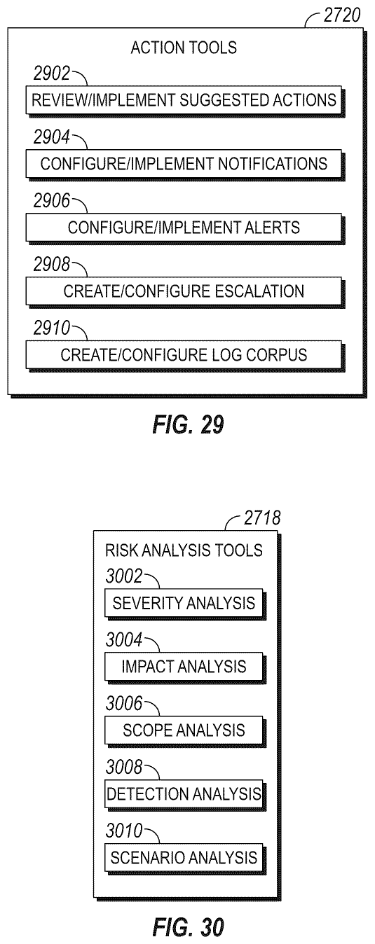

FIG. 29 is a block diagram depicting action tools, according to certain embodiments of the present disclosure;

FIG. 30 is a block diagram depicting risk analysis tools, according to certain embodiments of the present disclosure;

FIG. 31 is a flowchart depicting a method for on-vehicle intrusion detection, according to certain embodiments of the present disclosure;

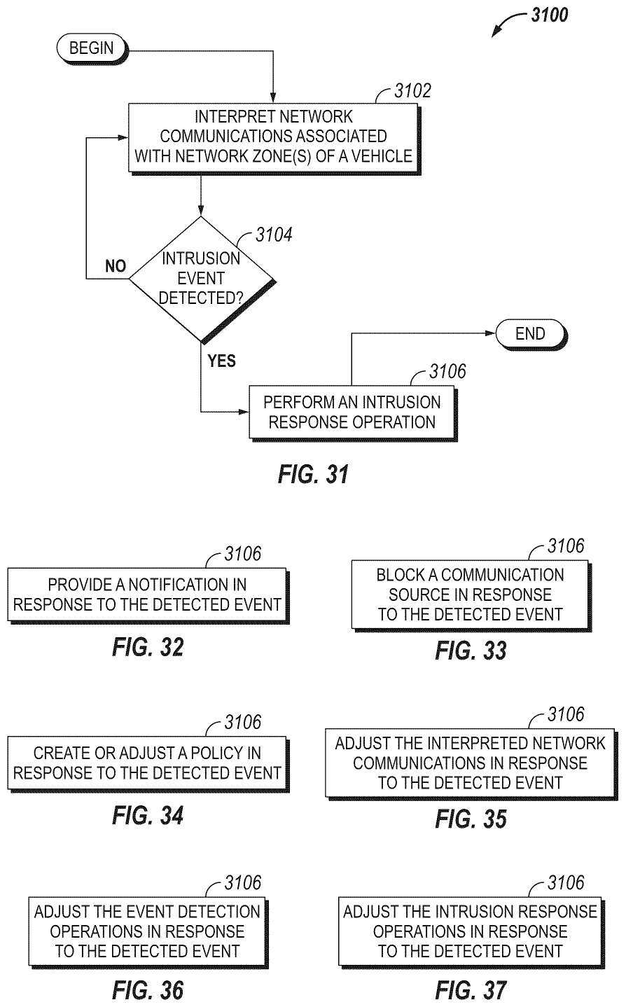

FIG. 32 is a block diagram depicting an intrusion response operation for the method of FIG. 31, according to certain embodiments of the present disclosure;

FIG. 33 is another block diagram depicting an intrusion response operation for the method of FIG. 31, according to certain embodiments of the present disclosure;

FIG. 34 is another block diagram depicting an intrusion response operation for the method of FIG. 31, according to certain embodiments of the present disclosure;

FIG. 35 is another block diagram depicting an intrusion response operation for the method of FIG. 31, according to certain embodiments of the present disclosure;

FIG. 36 is another block diagram depicting an intrusion response operation for the method of FIG. 31, according to certain embodiments of the present disclosure;

FIG. 37 is another block diagram depicting an intrusion response operation for the method of FIG. 31, according to certain embodiments of the present disclosure;

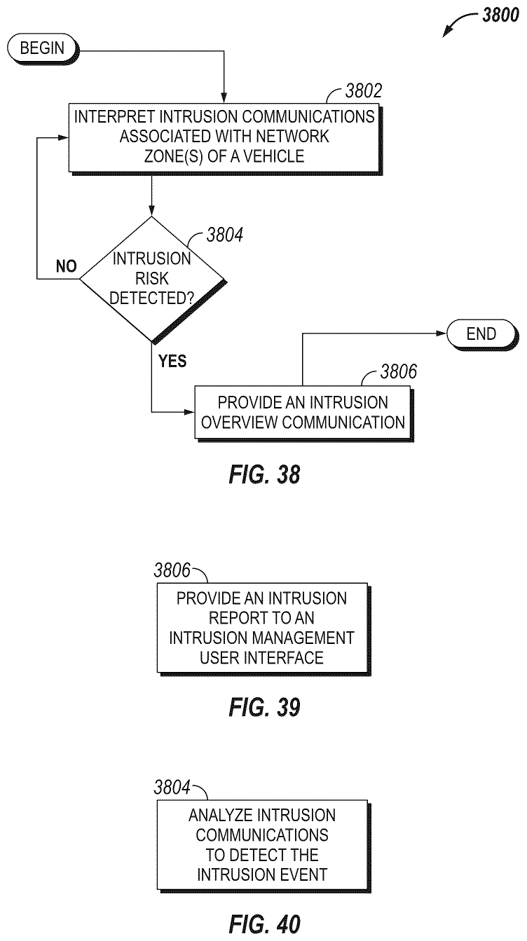

FIG. 38 is a flowchart depicting a method for cloud-based monitoring and analysis of intrusion detection information, according to certain embodiments of the present disclosure;

FIG. 39 is a block diagram depicting an intrusion overview communication of the method of FIG. 38, according to certain aspects of the present disclosure;

FIG. 40 is another block diagram depicting an intrusion overview communication of the method of FIG. 38, according to certain aspects of the present disclosure;

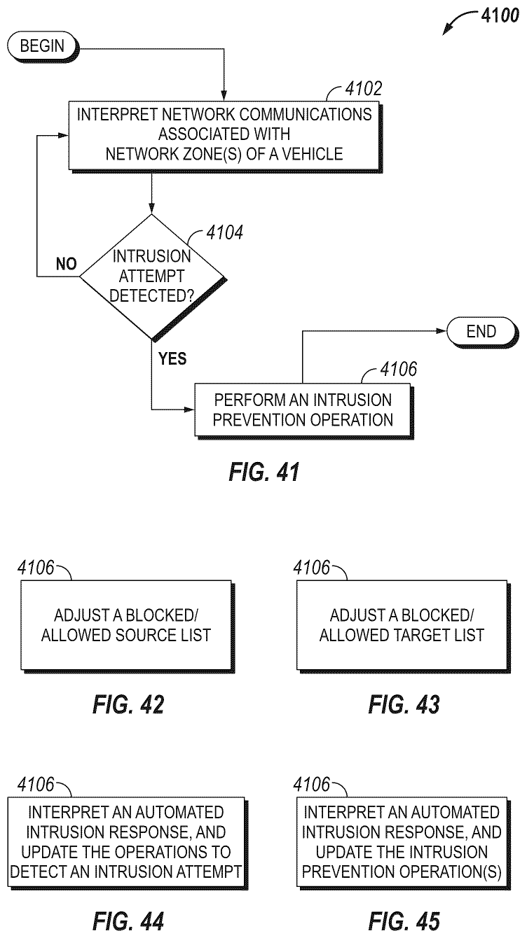

FIG. 41 is flowchart depicting a method for intrusion prevention operations, according to certain embodiments of the present disclosure;

FIG. 42 is a block diagram of an intrusion prevention operation for the method of FIG. 41, according to certain embodiments of the present disclosure;

FIG. 43 is another block diagram of an intrusion prevention operation for the method of FIG. 41, according to certain embodiments of the present disclosure;

FIG. 44 is another block diagram of an intrusion prevention operation for the method of FIG. 41, according to certain embodiments of the present disclosure;

FIG. 45 is another block diagram of an intrusion prevention operation for the method of FIG. 41, according to certain embodiments of the present disclosure;

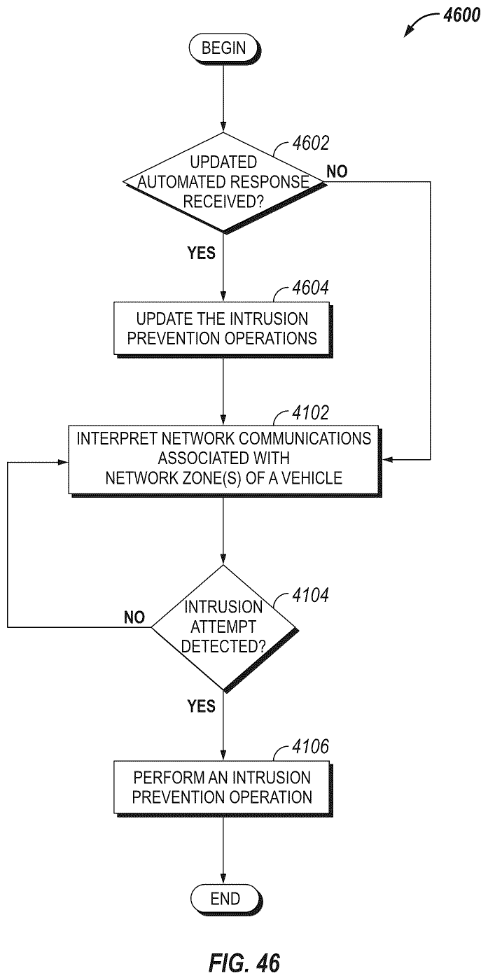

FIG. 46 is a flowchart depicting another method for intrusion prevention operations, according to certain embodiments of the present disclosure;

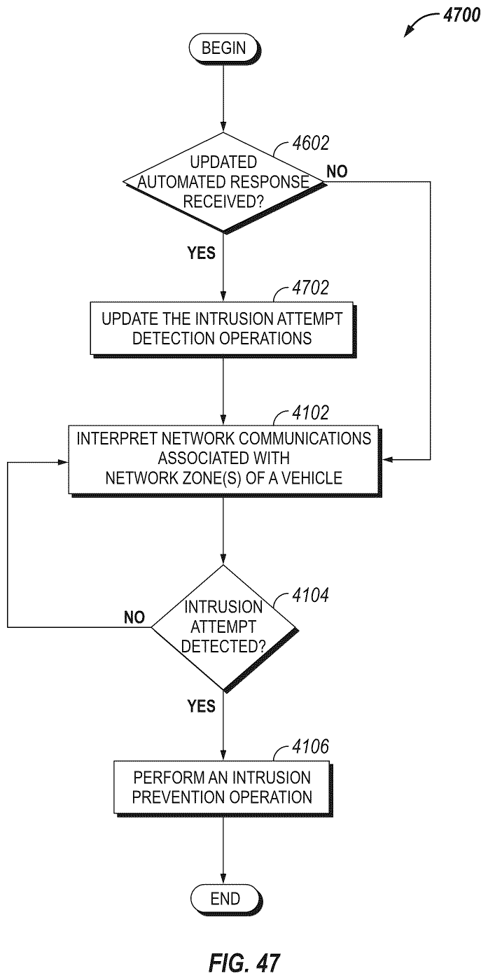

FIG. 47 is a flowchart depicting another method for intrusion prevention operations, according to certain embodiments of the present disclosure;

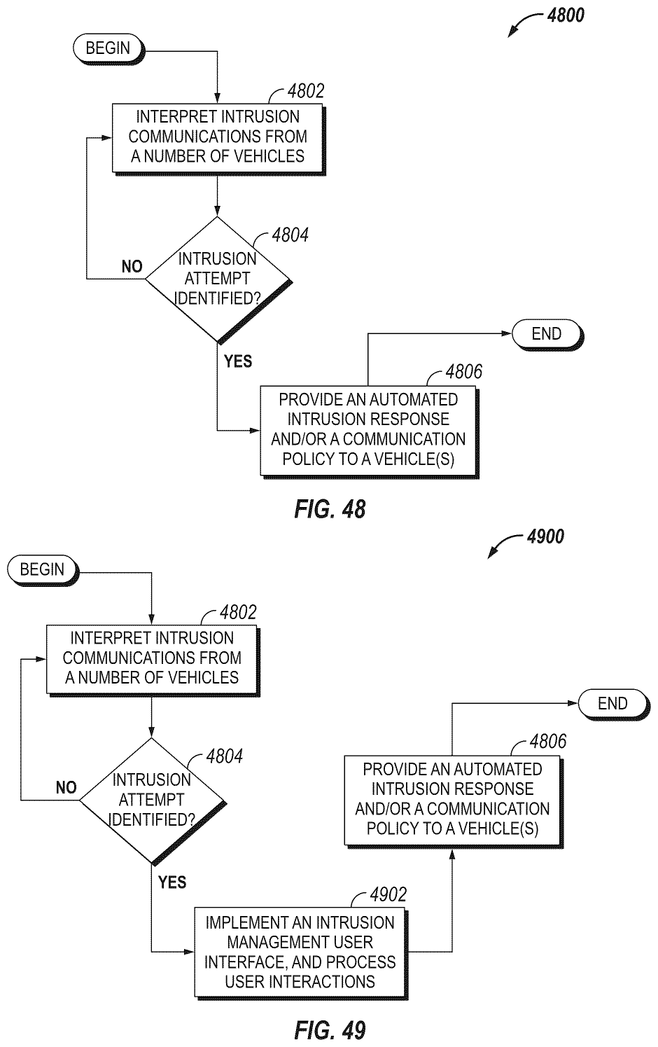

FIG. 48 is a flowchart depicting another method for intrusion prevention operations, according to certain embodiments of the present disclosure;

FIG. 49 is a flowchart depicting another method for intrusion prevention operations, according to certain embodiments of the present disclosure;

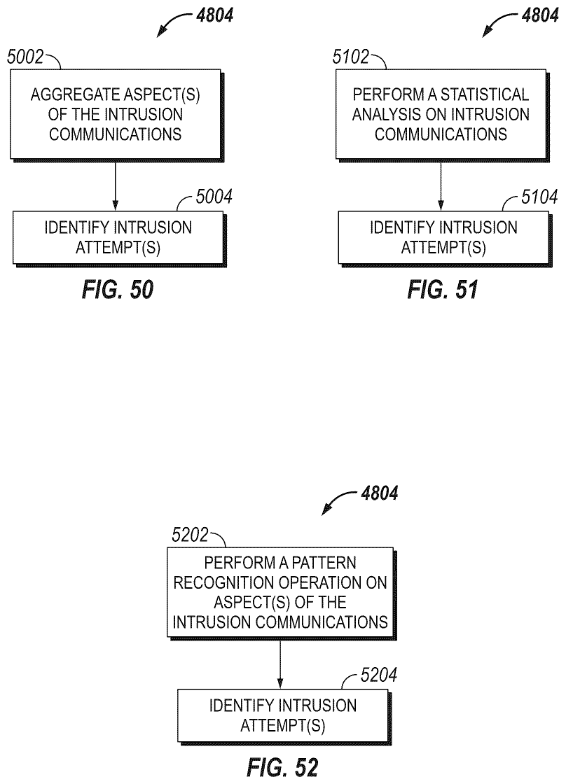

FIG. 50 is a flowchart depicting a method for identifying an intrusion attempt, according to certain embodiments of the present disclosure;

FIG. 51 is a flowchart depicting another method for identifying an intrusion attempt, according to certain embodiments of the present disclosure;

FIG. 52 is a flowchart depicting another method for identifying an intrusion attempt, according to certain embodiments of the present disclosure;

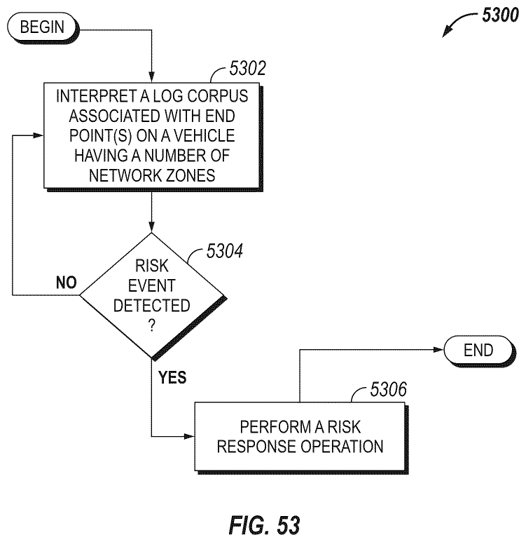

FIG. 53 is a flowchart depicting a method for monitoring and analyzing logs, according to certain embodiments of the present disclosure;

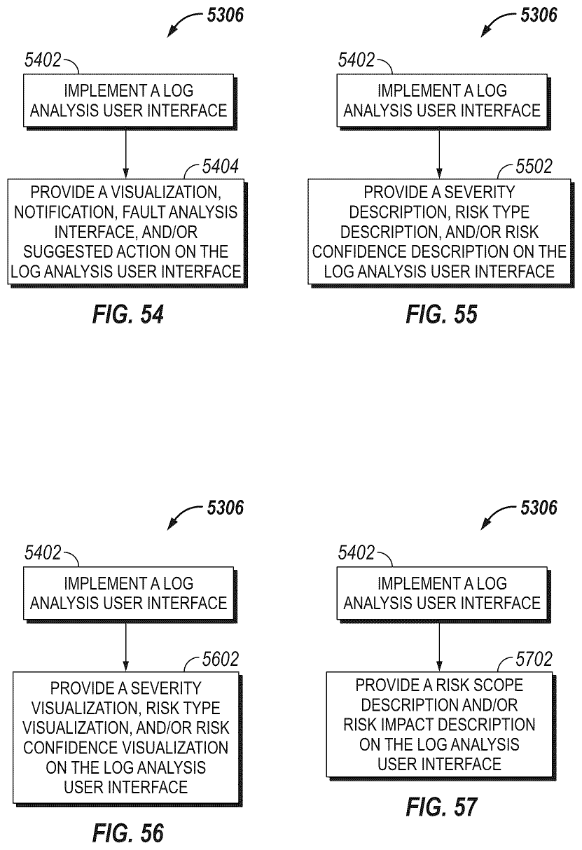

FIG. 54 is a flowchart depicting a method for performing a risk response operation, according to certain embodiments of the present disclosure;

FIG. 55 is a flowchart depicting another method for performing a risk response operation, according to certain embodiments of the present disclosure;

FIG. 56 is a flowchart depicting another method for performing a risk response operation, according to certain embodiments of the present disclosure;

FIG. 57 is a flowchart depicting another method for performing a risk response operation, according to certain embodiments of the present disclosure;

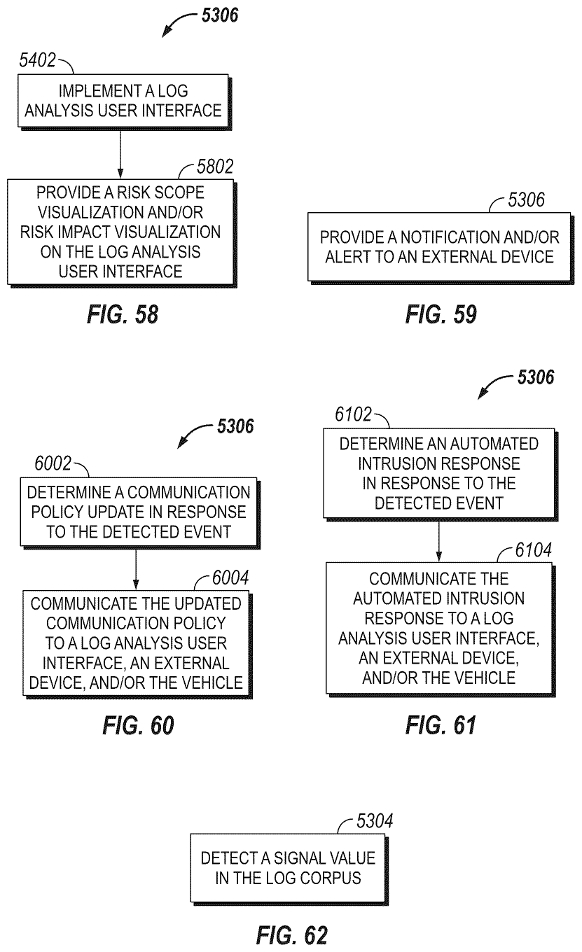

FIG. 58 is a flowchart depicting another method for performing a risk response operation, according to certain embodiments of the present disclosure;

FIG. 59 is a flowchart depicting another method for performing a risk response operation, according to certain embodiments of the present disclosure;

FIG. 60 is a flowchart depicting another method for performing a risk response operation, according to certain embodiments of the present disclosure;

FIG. 61 is a flowchart depicting another method for performing a risk response operation, according to certain embodiments of the present disclosure; and

FIG. 62 is a flowchart depicting another method for performing a risk response operation, according to certain embodiments of the present disclosure.

### DETAILED DESCRIPTION

Systems, procedures, apparatuses, assemblies, and the like are described herein for network protection operations in the context of mobile applications having a number of network zones.

Network zones may be embodied in separate network hardware, for example two ethernet networks embodied in distinct hardware backbones, with an ethernet gate or similar control aspect positioned between the networks. Network zones may include networks having distinct network types (e.g., ethernet, CAN, LIN, etc.), distinct protocols, distinct architectures, or the like. In certain embodiments, distinct network zones may be separate virtual networks, for example two ethernet networks operating on a same hardware backbone, architecture, and/or protocols, where the networks are separated virtually (e.g., using encryption or other techniques understood in the art), for example to separate networks by function, according to permissions, or the like.

Referencing FIG. 1, an example 100 vehicle 102 includes a number of networks 106, 108 and a number of end points 110 associated with each network 106, 108. The networks 106, 108 may be of any type, for example an Ethernet, controller area network (CAN), and/or any other type of network. The networks 106, 108 may be different types of networks, and/or the vehicle 102 may include more than one of a same type of network. The networks 106, 108 may be separated physically (e.g., operating on at least partially separate hardware) and/or logically (e.g., virtual networks operating on the same hardware). End points 110 may be any type of device at least selectively coupled to a network, such as a sensor, actuator, controller, ECU, or the like, including for example devices that have a network address or identifier.

The example vehicle 102 includes a controller 104 that controls some or all of the network traffic, for example registering devices, allowing or disallowing communications, operating services (including registration of services, managing subscriptions, managing related data storage and communications, etc.), controlling access of end points 110 to external devices 112 (e.g., to an external user 114), controlling access of external device 112 to end points 110, and/or controlling inter-network communications (e.g., transferring messages from one network to another, etc.). The example controller 104 may itself be an end point 110 (or more than one end point) on one or more of the networks. The controller 104 is depicted as a single device for clarity of the present description, but the controller 104 may be a distributed device (e.g., with control portions positioned on several devices), and/or may include aspects that are positioned off-vehicle (e.g., on a service tool, fleet computing device, application on a cloud server, etc.). The example controller 104 includes one or more circuits and/or components configured to functionally execute operations of the controller (e.g., reference FIG. 2). The circuits and/or components may be single devices, for example positioned on a computing device of the vehicle and/or an external device, but may additionally or alternatively be distributed in whole or part across several devices.

A circuit and/or a component, as utilized herein, includes one or more hardware aspects configured to perform the operations of the circuit and/or component, for example a sensor, actuator, logic circuit, a hardware element configured to be responsive to perform operations of the circuit, executable code stored on a computer readable medium and configured to cause a processor to perform one or more operations of the circuit and/or component when executed, and/or combinations of these. A circuit and/or component should be understood broadly to describe a configuration of hardware and/or executable instructions, including elements that are cooperative directly and/or logically, to perform the operations of the circuit and/or component.

The embodiment depicted in FIG. 1 may be utilized with, and/or may embody in whole or part, any other embodiments set forth throughout the present disclosure, including embodiments to perform intrusion detection, prevention, and/or mitigation, and/or embodiments to perform log analysis to detect anomalous and/or risk conditions that may be present on the vehicle 102 and/or a controller 104 supporting the vehicle 102.

Embodiments throughout the present disclosure may be embodied, at least in part, utilizing controllers, circuits, components, processors, and/or operations such as those set forth in one or more of the following patents or patent applications: U.S. application Ser. No. 17/027,167, filed 21 Sep. 2020, and entitled SYSTEM, METHOD, AND APPARATUS TO SUPPORT MIXED NETWORK COMMUNICATIONS ON A VEHICLE (SONA-0006-U01), now U.S. Pat. No. 11,411,823 issued on 9 Aug. 2022; U.S. application Ser. No. 17/027,187, filed 21 Sep. 2020, and entitled SYSTEM, METHOD, AND APPARATUS TO EXTRA VEHICLE COMMUNICATIONS CONTROL (SONA-0007-U01), now U.S. Pat. No. 11,228,496 issued on 18 Jan. 2022; U.S. application Ser. No. 17/195,589, filed 8 Mar. 2021, and entitled SYSTEM, METHOD, AND APPARATUS FOR MANAGING VEHICLE DATA COLLECTION (SONA-0010-U01), now U.S. Pat. No. 11,538,287 issued on 27 Dec. 2022; and U.S. application Ser. No. 17/833,614, filed 6 Jun. 2022, and entitled SYSTEM, METHOD, AND APPARATUS FOR MANAGING VEHICLE DATA COLLECTION (SONA-0012-U01), published as US 2022/0297635 A1 on 22 Sep. 2022, each of which is incorporated herein by reference in the entirety for all purposes. For example, operations to manage intra-network and/or inter-network communications on a vehicle, including adjusting the management based on changes to a policy or the like, may utilize embodiments as set forth in application '167; operations to manage communications between any end point and external devices, including adjusting the managing based on changes to a policy or the like, may utilize embodiments as set forth in application '187; operations to manage data collection operations, including adjusting data collection, formatting, and/or configuration of data, data life cycle management, and communication of collected data, may utilize embodiments as set forth in application '589; and/or operations to implement, execute, and otherwise manage automated vehicle operations, including operations that can be implemented without software or firmware updates being required, may utilize embodiments as set forth in application '614.

Certain operations are described herein as interpreting one or more parameters. Operations to interpret a parameter include, without limitation, receiving data indicative of the parameter (e.g., a network communication, stored memory value, etc.), receiving representative data from which the parameter can be calculated and/or determined, determining the value directly (e.g., using a sensor), and/or combinations of these. In certain embodiments, operations to interpret a parameter may vary depending on operating conditions, for example using a first operation to determine the parameter at a first operating condition, and using a second operation to determine the parameter at a second operating condition (e.g., where the quality of the parameter determination varies depending upon operating condition, using alternative operations as a back-up in response to suspect and/or unavailable data, etc.).

Referencing FIG. 2, an example controller 104 includes a network management circuit 202 that controls communications 212 of end points between networks of the vehicle, and controls communications 212 between end points and at least one external network and/or external device. Control of communications 212 includes one or more of: allowing end points to send and/or receive data, controlling data rates, enforcing network protocols, enforcing data identification and/or formatting, executing authorization procedures (e.g., login, registration, addressing, identification, encryption, etc.), relating and/or controlling communications as a group (e.g., communications related to a flow, related to a service provider, related to a particular network, etc.), and/or controlling intra-network communication (e.g., packaging and/or encapsulation of messages, message formatting, message protocol adjustments, down-sampling and/or up-sampling messages, etc.). In certain embodiments, control of communications 212 is responsive to a policy, for example describing allowed operations, communications, devices, quality of service, etc., which may be provided by a manufacturer, OEM, service entity, dealer, owner, operator, or the like, and which may be provided at a time of vehicle manufacture, assembly, and/or which may be provided and/or updated from an external device (e.g., service tool, manufacturing tool, cloud application, etc.). In certain embodiments, the network management circuit 202 controls shared memory utilization (e.g., where several end points share memory resources provided on another end point or set of end points) and/or processing redundancy (e.g., where multiple controllers are capable to provide control operations for one or more aspects of the vehicle, whether the capability is identical (e.g., either one of two controllers can perform engine control operations) or not (e.g., a first controller is capable to provide primary engine control operations, while a second controller is capable to provide secondary engine control operations which may be of a lower or alternative capability).

The example controller 104 includes a unified intrusion detection circuit 204 that interprets network communications 214 (e.g., the communications 212 and/or a subset of the communications 212) on the networks of the vehicle, and determines an intrusion event value 216 in response to the network communications. Example and non-limiting operations to determine the intrusion event value 216 include one or more of: determining an unknown packet value is present (e.g., a packet is present on a network that is from an unknown source, ambiguous source, being sent to an unknown destination, ambiguous destination, etc.); an unknown connection value (e.g., determining that communications are present from an unknown and/or ambiguous connection); a communication frequency value (e.g., a communication is present that is provided above a frequency threshold rate, provided at an unauthorized rate, provided at a rate that is different from an expected, defined, and/or commanded rate, etc.); a communication count value (e.g., a communication has occurred a number of times exceeding a threshold value, for example from a known device that should be communicating a different number of times, and/or an unknown device that has exceeded a threshold number of times—for example allowing the system to ignore transient or one-off unknown communications); a data rate value (e.g., communications that result in a data rate that exceeds a threshold value, that is not expected based on the communicating device, that is different from a commanded and/or defined value, etc.; for example communications related to an end point, flow, application, service provider, network, and/or communication device such as an external device, access point name, etc.); a communication sequence value (e.g., considering the timing and/or progression of communications, communications with sequenced addresses that appear to be searching for legitimate end points, etc.); an unexpected diagnostic value (e.g., execution of an unauthorized diagnostic, execution of a diagnostic that is not expected—for example related to an end point that is not active and/or is not expected to be executing a given diagnostics, execution of a diagnostic that is not authorized at least under the present operating conditions, etc.); an end point status value (e.g., communications to or from an end point that is not present, is currently disabled, is not currently installed, etc.); a protocol value (e.g., a communication utilizing an improper, out-of-date, or other off-nominal aspect of a protocol); a packet parsing value (e.g., a packet that appears to be built improperly and/or inconsistently between messages, a packet providing a payload that has an unexpected and/or invalid value, etc.); and/or an address resolution protocol attack (e.g., a communication or group of communications that appear to be executing an ARP attack, for example attempting to register as a legitimate device). It can be seen that the operations of the network management circuit 202, for example allowing for observation and coordination of analysis across multiple networks, can enhance the intrusion detection, for example protecting all of the vehicle networks, allowing for agglomeration of messages on multiple networks when determining if an intrusion is occurring, or the like. In certain embodiments, an intrusion event value 216 indicates that an attack is active, an attack has occurred in the past, an attack is being revived, and/or that suspicious activity is present that may be an indicator of an attack. In certain embodiments, the unified intrusion detection circuit 204 determines an attack is present (or not present) in response to categorical information, such as an approved list (e.g., approved end points, external device(s), external networks, etc.) and/or a blocked list (e.g., known malicious and/or unauthorized addresses, external device(s), external networks, etc.). In certain embodiments, for with example communications relating to an approved listed device, an intrusion event value 216 may be determined that an attack or suspected attack is being attempted, even though the device is approved—for example where a communication inconsistent with a protocol, communication standard, or the like is detected.

The example controller 104 includes a unified intrusion mitigation circuit 206 that performs an intrusion mitigation action 218 in response to the intrusion event value 216 and/or an intrusion response instruction 228. An example intrusion response instruction 228 includes a notification description 230 (e.g., reference FIG. 3), for example including a notification type 302 (e.g., e-mail, network communication, text message, etc.), a notification target 304 (e.g., end point, external device, person and/or entity, e-mail address, phone number, memory location, cloud application, end point, etc.), and/or a notification content 306 (e.g., data to be included in the notification, such as the type of event, related data utilized to determine the event, data utilized to confirm the event (e.g., where confirmation operations may be performed off-vehicle), a confidence value associated with the event, a severity value associated with the event, etc.). In certain embodiments, more than one notification 222 may be provided, for example a text message, fault code, etc., may be provided with a limited amount of information in a first notification, and a more extensive amount of information may be stored in a specified location for access in response to the first notification. In certain embodiments, various notifications 222 having varying content may be sent to more than one notification target (e.g., an owner, operator, fleet owner, service personnel, manufacturer, OEM, and/or administrator, etc. may receive notifications having distinct content).

In certain embodiments, operations of the unified intrusion mitigation circuit 206 may include one or more of: blocking a data source, external network, end point, etc. from sending and/or receiving communications; updating a categorical list (e.g., of approved, authorized, and/or malicious addresses); updating a communication control parameter (e.g., adjusting or limiting a data rate, communication count, etc., of an end point, network, address, flow, application, etc. related to the event); and/or collecting and/or storing data related to the event and/or tending to further confirmation and/or clearing of the event (e.g., incrementing or decrementing a counter, etc.). In certain embodiments, actions to be performed by the unified intrusion mitigation circuit may be provided, in whole or part, as a part of a policy, intrusion response description, notification description, or the like. In certain embodiments, the policy, intrusion response description, notification description, and/or other actions of the unified intrusion mitigation circuit may be updated by an external device (e.g., operated by an owner, operator, service personnel, manufacturer, administrator, etc.), and/or in response to an event occurring in an offset vehicle (e.g., a related vehicle of a group, for example as a part of a fleet, vehicle make and/or model, vehicle trim, manufacturer, vehicles sharing an aspect of a software build, etc.). An administrator may be any person and/or entity associated with the vehicle, for example network security provider, cloud application provider, a service provider, a manufacturer, and/or a third-party associated with, authorized by, and/or employed by any of these.

An example controller 104 includes a unified intrusion prevention circuit 208 that performs an intrusion prevention action 220 in response to the intrusion event value 216 and/or the intrusion response instruction 228. Example and non-limiting intrusion prevention actions 220 include one or more of: disabling an end point; disabling communications from a network, external network, address, entity, geographic source or destination, etc.; disabling a network of the vehicle; disabling a controller of the vehicle (and/or sourcing one or more functional aspects of the controller to another controller); disabling a memory location on the vehicle (and/or utilizing an alternate memory location for all or a portion of the data that was previously stored in the disabled location); disabling and/or reducing a capability of the vehicle; and/or disabling and/or reducing a capability of an application and/or flow of the vehicle. In certain embodiments, operations of the unified intrusion prevention circuit 208 are responsive to an update of the policy, an event detected in an off-set vehicle, a communicated automated vehicle response, an enabled automated vehicle response, and/or an event detected in an off-vehicle location, such as an event related to a cloud application utilized by the vehicle and/or a flow of the vehicle, and/or an event related to an offset vehicle, such as another vehicle of the same make or model year, and/or sharing a characteristic related to a detected event, such as a same end point, ECU, flow, application, or the like.

The description of operations performed by the unified intrusion mitigation circuit 206 and the unified intrusion prevention circuit 208 are non-limiting examples. Further, the utilization of separate mitigation and prevention functionality is for illustration to demonstrate certain capabilities and operations of the system. A given operation may be performed as either mitigation or prevention, and the categorization as either mitigation or prevention, or inclusion as both mitigation and prevention, is not limiting to the underlying operations. Accordingly, a given response operation is contemplated herein as available to be performed by a mitigation circuit 206, a prevention circuit 208, or both.

An example controller 104 includes the network management circuit 202 interpreting an intrusion management policy 226, which may form all or a portion of a policy, a communication policy, or other similar terminology as set forth throughout the present disclosure. Certain actions may be implemented by creating or adjusting a policy, by creating, adjusting, or enabling an automated vehicle response, and/or by providing a data collection request to the vehicle. Certain actions are described, for clarity of the present description, as utilizing one or more of these levers to adjust vehicle operations and thereby provide for detection, notification, mitigation, and/or prevention of intrusive communications and/or as responses to anomalous conditions detected by log analysis, but it is understood that other levers could be utilized in the alternative. An example intrusion management policy 226 includes the intrusion response instruction(s) 228, notification description(s) 230, and/or other responses, data collection, etc. to be performed to determine whether an intrusion event has occurred, the severity of the event, to characterize the event, and/or to take actions (e.g., mitigation and/or prevention) in response to the detection of an event or suspected event. In certain embodiments, the intrusion management policy 226 may be included within and/or associated with a policy that includes other network management information, such as data collection descriptions, authorization values, network control parameters, or the like. The existence of and organization of an intrusion management policy 226 is a non-limiting example.

An example intrusion event 216 includes a determined attack and/or a suspected attack, and an example intrusion response instruction 228 includes an intrusion report description. An example intrusion report description includes one or more of: an intrusion time value (e.g., a time stamp, related calendar time, time window, etc.); an intrusion severity description (e.g., quantitative such as a # of communications, capability loss description, affected end points and/or flows, etc.; and/or qualitative such as low-medium-high, mission affecting, attack relating to particular data types such as control operations, peripherals, personally identifiable information, etc.); an intrusion type description (e.g., spoofing, fishing, denial of service, etc.); an intrusion data value (e.g., message information, information utilized to confirm, network activity at the time, and/or any other data related to the event and/or collected in response to the event); an intrusion connection detail (e.g., source address, affected addresses, destination address, addresses and/or identifiers related to the event, etc.); an intrusion confidence description (e.g., a heuristic, expert system based, and/or statistical description of a confidence value in the determination that the event is an actual attack and/or related to any aspect of the event such as the type of attack, the quality of information related to the attack, or the like); and/or an intrusion scope value (e.g., a number of vehicles that are affected by and/or likely to be affected by the intrusion event, which features, flows, applications, and/or end points are affected, etc.).

An example unified intrusion mitigation circuit 206 and/or unified intrusion prevention circuit 208 determines an enhanced data collection value 224 (e.g., additional data to be collected in response to an attack or a suspected attack, for example defined in the intrusion management policy 226) in response to the intrusion event value 216, and the network management circuit 202 collects data responsive to the enhanced data collection value 224. In certain embodiments, actions such as providing the report, performing intrusion prevention actions 220, and/or performing intrusion mitigation actions 218, may be performed in whole or part by an intrusion reporting circuit 210.

Without limitation to any other aspect of the present disclosure, the embodiment of FIG. 2 may be utilized, in whole or part, with any other systems, controllers, devices, procedures, and/or operations as set forth herein. For example, components herein (e.g., reference FIGS. 7, 10, 14, 16, and 19) may be embodied, in whole or part, in circuits or other aspects of controller 104 as set forth in FIG. 2. In certain embodiments, procedures set forth herein may be performed, in whole or part, by any components, circuits, controllers, or the like as set forth throughout the present disclosure.

Referencing FIG. 4, an example intrusion detection system 400 for an Ethernet (EIDS) network of a vehicle is schematically depicted. The example of FIG. 4 is depicted in the context of an Ethernet network as an illustration, but the EIDS may be operated in the context of any type of network, and across more than one network separately (e.g., with the network management circuit aggregating the separate information) and/or simultaneously. In certain embodiments, aspects of the EIDS may be implemented, in whole or part, on a controller such as that depicted in FIG. 2, and/or on an external device and/or cloud application. The example EIDS includes an EIDS configuration manager 402, for example receiving and implementing an intrusion management policy, and which may further include interacting with external device(s) and/or a cloud application, for example allowing any entities and/or personnel herein to provide updates (e.g., with proper authorization) to the intrusion management policy. The example EIDS includes an EIDS reporter 404, for example to execute notifications, and/or to store and/or transmit intrusion reports (e.g., responsive to the intrusion report description). The example EIDS includes an EIDS rules engine including a connection analyzer 406 that performs intrusion detection operations consistent with the intrusion management policy, and related to end points, devices, external networks, and/or other source/destination aspects of intrusion detection. The example EIDS rules engine includes a protocol analyzer 408 that determines intrusion events based on the content of communications, including packet payloads, packet headers, protocol determinations, or the like. The example EIDS rules engine includes a rate analyzer 410 that determines intrusion events based on the rate and/or count of communications. The example EIDS includes an EIDS packet engine that includes a packet receiver 412 (e.g., interpreting packets and/or network communications), a packet parser 414 (e.g., determining headers, payloads, metadata, and the like from individual packets), and a packet classifier 416 (e.g., determining related flows, applications, end points, data types, etc. related to the packet(s) and/or a group of packets). The example of FIG. 4 is a non-limiting illustration, and operations of an intrusion detection, mitigation, and/or prevention system as described herein may be organized in any manner.

An example system includes an IDS for each type of network in the vehicle, and/or for each network in the vehicle. For example, a given system may include an EIDS, a CAN IDS (e.g., an IDS for a CAN network), and/or a unified IDS (e.g., aggregating information across the individual network IDS components). An example unified IDS provides for a consistent configuration environment, reporting and/or notification environment, user interface, controller interface, and/or API for updating, configuring, installing, and/or receiving information from the IDS for the vehicle.

Referencing FIG. 5, an example system 500 including a vehicle-side and cloud-side intrusion detection and prevention system is schematically depicted. The example system 500 includes a cloud-side implementation including a security operation center 502 to monitor and report on detected events on the vehicle, to provide for alert and escalation operations in response to events and/or information from event reports, a security suggestion and/or prevention component 510 (e.g., providing a responsible entity with mitigating and/or prevention activities to be performed, best practices, etc.), and a security policy management component 514 configured to allow users (e.g., any entity and/or personnel described herein, with appropriate authorization) to implement updates to the intrusion management policy. The cloud-side implementation includes a security alert and escalation component 512 configured to provide alerts and notifications according to selected settings, including escalation of alerts and/or notifications based on the detected severity, scope, time since detection, or the like. The cloud-side implementation includes a security monitor and report component 516 configured to provide visualizations, dashboards, host information for access by appropriate users, or the like, and to configure detected event information for utilization by other components of the security operation center 502. The example of FIG. 5 includes a data flow 506, such as data passing between components, and a control flow 508, such as commands, instructions, or the like passing between components. The cloud-side implementation of FIG. 5 allows for a user to rapidly configure intrusion policies or other responses using a consistent interface, including to a single vehicle and/or to a group of vehicles in a single operation.

The example of FIG. 5 includes a vehicle-side implementation, for example embodied as a security solution 504 on a vehicle, using a UIDS at described throughout the present disclosure, and including components allowing for vehicle automation 518 (e.g., allowing for responses of the vehicle to intrusion events, for example moving controls and/or storage to safe locations, adjusting vehicle operations such as power limits, shutdown, operating cameras and/or lights, etc.), and a dynamic policy manager component 520 to allow for updates, configuration, and scheduled implementation of policies. The example of FIG. 5 includes a vehicle data collection component 522 to control collection of data (e.g., intrusion events, related information, information for notifications and/or reporting, data to confirm, verify, and/or clear suspected intrusion events, etc.), and components to control intra-network communications 528, inter-network communications 524, and extra vehicle communications 526 of the vehicle. Aspects of the system of FIG. 5, including but not limited to the vehicle-side aspects, may be embodied, in whole or part, on a controller such as that depicted in FIG. 2, and the distribution of components and responsibilities between the vehicle and the cloud is a non-limiting example.

Referencing FIG. 6, an example universal intrusion detection and prevention system (UIDPS) 600 on a vehicle 102 is schematically depicted, with example features and capabilities described in relation thereto. The example of FIG. 6 depicts an intruder source 608 sending an intruding communication 606 to the vehicle 102, for example an unauthorized communication to send a command to, and/or request information from, an end point on the vehicle 102. The example of FIG. 6 includes a vehicle controller 104A configured to detect the intruding communication 606, and to provide intrusion information 602 to a cloud controller 104B. In the example of FIG. 6, the cloud controller 104B provides a prevention policy 604, for example a policy adjusted to respond to the intruder source 608 and/or the intruding communication 606, to prevent access and/or interference by the intruding communication 606. The example of FIG. 6 is non-limiting—for example, detection of the intruding communication 606 may be performed on the cloud controller 104B (e.g., analyzing network communications of the vehicle 102, analyzing a log corpus from the vehicle, and/or combining such information from the vehicle with similar information from a number of other vehicles to determine that the communication is an intruding communication 606), prevention of the intruding communication 606 may be performed on the vehicle controller 104A (e.g., communication from the unknown address, and/or communications that are sent to a sensitive network and/or sensitive end point, may be blocked indefinitely and/or until the communications can be confirmed), and/or prevention operations may utilize an automated vehicle response (e.g., a response already on the vehicle, which may be enabled in response to detecting the intrusion, and/or a response sent to the vehicle from the cloud controller 104B or another external device) instead of, or in addition to, a policy based response.

Without limitation to any other aspect of the present disclosure, a policy, as utilized herein, includes any one or more of: a description of data to be collected, such as data parameters, collection rates, resolution information, priority values (e.g., ordering data collection values for selection in response to off-nominal conditions where not all data collection parameters can be serviced, etc.); a description of authorized communication sources (e.g., allowed addresses, entities, digital signatures, etc.); a description of authorized communication targets (e.g., end points on the vehicle, with associated permissions, and/or off-vehicle end points that may be communicated with, including with associated permissions); and/or a description of authorized network communications for end points (e.g., allowed communication rates, data rates, data values, etc. that can be utilized by end points on-or off-vehicle). In certain embodiments, a policy further includes event information, which may be stipulated as parameter or quantitative based events (e.g., a given data value exceeds a threshold, etc.), and/or categorical events (e.g., a particular fault code, operational condition or state, or vehicle location/jurisdiction occurs). In certain embodiments, a policy further includes an event response, such as data values to be captured in response to the occurrence of the event, and/or other changes in the data collection scheme such as increased or reduced data collection rates, changes in collected resolution, or the like. In certain embodiments, an event response further includes a time frame associated with the event occurrence, for example a time period after the event occurrence to utilize the adjusted data collection scheme, and/or a time period preceding the event occurrence (e.g., utilizing a rolling buffer or other data collection operation, providing temporary information that can subsequently be captured if the event occurs). In certain embodiments, changes to the data collection scheme for an event can include multiple changes—for example changes over a period of time, further changes based upon the progression of the event (e.g., if the event severity gets worse), and/or criteria to determine that an event is cleared. In certain embodiments, changes to a data collection scheme may be implemented based on event related clearance of the same or another event, for example implementing a data collection change until a next shutdown event of the vehicle, until a service technician clears the event, for a selected number of shutdown events occurs, or the like.

An example system includes the controller detecting an abnormal behavior (e.g., an intrusion, attack, or a suspected one of these, and/or an intrusion event value indicating one of these), communicating the abnormal behavior to the cloud (e.g., as a notification, report, etc.), and a user and/or cloud application evaluates the communication to determine whether an actual event has occurred. In certain embodiments, the user and/or cloud application creates a policy and/or an update to the policy responsive to the attack, for example implementing an action to block, mitigate, and/or prevent the attack or attacks of a similar type.

An example system includes the vehicle automation manager 518 (e.g., reference FIG. 5) having an algorithm, application, evaluation criteria, or the like, that determines whether an actual intrusion and/or attack is present based on predetermined criteria (e.g., reference claim 4 herein, and/or operations of the EIDS rules engine), and/or includes preventative, blocking, and/or mitigating actions to be taken in response to detection of an actual or suspected intrusion event or attempt. The example vehicle automation manager 518 further includes one or more recipes, response instructions, or the like, indicating actions to block, mitigate, and/or prevent attacks, for example based on attack types, severity, frequency, or the like. The example system includes the controller 104 detecting an abnormal behavior, communicating the abnormal behavior to the vehicle automation manager 518, and the vehicle automation manager 518 determining whether the abnormal behavior is an actual event, and further instructing the controller 104 to execute operations, based on the recipes and/or response instructions, to block, mitigate, and/or prevent the attack or attacks of a similar type.

The description herein utilizing off-vehicle, extra-vehicle, and/or cloud-based interactions, and/or communications to an external device, references any external network communications of the vehicle, including without limitation wireless-based communications (e.g., mobile data, WiFi, and/or Bluetooth) to external devices. Communications to external devices may be to a general network (e.g., over the internet), a WAN, a LAN, a mobile device in proximity to the vehicle, and/or combinations of these. Certain systems and procedures described herein particularly contemplate run-time operations of the vehicle, for example external communications occurring during operating conditions wherein the vehicle is executing a mission (e.g., moving, performing operations while not moving, etc.). The disclosure herein further contemplates communications that may occur during any period, including during down-time of the vehicle and/or during service events. The disclosure herein further contemplates communications that may occur through wired communication channels, such as when the vehicle network is in communication with a service tool, on-board diagnostics (OBD) instrument, or other physically coupled device.

The description herein references vehicle applications as a non-limiting example and for clarity of the present description. However, embodiments herein are applicable to other applications having similar challenges and/or implementations. Without limitation to any other application, embodiments herein are applicable to any application having multiple end points, including multiple data sources, controllers, sensors, and/or actuators, and which may further include end points present in distinct or distributed network environments, and/or applications having historical or legacy networking or communication systems that may be transitioning (within a given system, as a class of systems, and/or as an industry) to newer and/or more capable networking or communication systems. Example and non-limiting embodiments include one or more of: industrial equipment; robotic systems (including at least mobile robots, autonomous vehicle systems, and/or industrial robots); mobile applications (that may be considered “vehicles”, or not) and/or manufacturing systems. It will be understood that certain features, aspects, and/or benefits of the present disclosure are applicable to any one or more of these applications, not applicable to others of these applications, and the applicability of certain features, aspects, and/or benefits of the present disclosure may vary depending upon the operating conditions, constraints, cost parameters (e.g., operating cost, integration cost, operating cost, data communication and/or storage costs, service costs and/or downtime costs, etc.) of the particular application. Accordingly, wherever the present disclosure references a vehicle, a vehicle system, a mobile application, industrial equipment, robotic system, and/or manufacturing systems, each one of these are also contemplated herein, and may be applicable in certain embodiments, or not applicable in certain other embodiments, as will be understood to one of skill in the art having the benefit of the present disclosure.

A flow, as utilized herein, should be understood broadly. An example flow includes a related group of data (e.g., speed data, temperature data, audio-visual data, navigation data, etc.), a related group of functions (e.g., among vehicle functions, extra-vehicle functions such as service operations and/or data collection, aggregations between related vehicles, and/or combinations of these that are related for a particular system, for example power train control, traction control, audio/visual system control, etc. may each be a flow; it will be seen that an end point may form all or a portion of a flow, and/or may be included in multiple flows), a related group of devices (e.g., door actuators), and/or a related group of applications. Flows, as used herein, provide an organizing concept that may be utilized to relate certain data, certain end points, certain applications, and/or related functions of the vehicle or apart from the vehicle. In certain embodiments, a controller can utilize a flow to identify a data source, a data destination, permissions available for the flow, priority information related to the flow, or the like, to implement certain data regulating operations here. In certain embodiments, the utilization of the flow allows the controller to perform separate operations that may involve the same end points to support the desired network management. For example, a vehicle speed management application may have a high priority, and a speedometer end point may be associated with the vehicle speed management application. In the example, if the vehicle speed is being communicated to support the vehicle speed management application, then the controller applies a high priority to the vehicle speed message. However, if the vehicle speed is being communicated to support a trip planning flow (e.g., where a trip planning flow is present and does not have a high priority), the controller may apply a lower priority to the vehicle speed message. In a further example, a failure of a vehicle controller, portion of a network, or other off-nominal condition may result in the migration of the vehicle speed management application to another controller in the system, whereby the vehicle speed message is being communicated (e.g., where the backup controller is on another network) to support the vehicle speed management application, and the controller may apply a higher priority to the vehicle speed message. The utilization of flows and applications to organize the components of the system allows for the same or similar information to be regulated by the controller in a differential manner to support various functions, allowing for improvements in the performance and security of network regulation operations (e.g., reducing unnecessary cross-network traffic, and providing information only as needed), and supports additional functionality relative to previously known systems, such as redundancy support, distributed control, and granular cross-network messaging.

Referencing FIG. 7, an example system 700 is utilizable with a vehicle having a number of network zones, each network zone including a number of end points. The example system 700 includes a controller 104 having a network monitoring component 702 configured to interpret network communications 708 associated with at least one of the network zones, a network intrusion detection component 704 configured to detect an intrusion event 712 in response to the network communications 708, and an intrusion response component 706 configured to perform an intrusion response operation 710 in response to the detected intrusion event 712. Example network communications 708 include any communications between end points on the vehicle (regardless of the network zone associated with the end points); communications between an end point of the vehicle and an external device, including communications to or from the vehicle, and to any external device such as the cloud server, a tool (e.g., service tool, manufacturing tool, etc.); and/or any communications to an application on an external device supporting the vehicle, such as communications to or from a cloud server having an application thereon to support vehicle operations. Example intrusion events 712 include communications that are unauthorized or suspected to be unauthorized, communications to or from unknown addresses, communications that are provided with an improper protocol, content, messaging frequency, or the like, communications that are targeted to an end point that is unauthorized or unexpected for messaging traffic (and/or messaging traffic of the type present in the network communications 708), and/or the presence of any other intrusive communication as set forth throughout the present disclosure.

In some aspects, the techniques described herein relate to a system, wherein the number of network zones include a number of ethernet based network zones. In some aspects, the techniques described herein relate to a system, wherein a first one of the number of network zones includes an ethernet based network zone, and wherein a second one of the number of network zones includes a controller area network (CAN) based network zone.

An example network intrusion detection component 704 is further configured to detect the intrusion event 712 in response to intrusion detection information 802 (e.g., reference FIG. 8), such as a communication source value 804 (e.g., an indication that the communication source is unknown, unauthorized, on a blocked list, unexpected, or the like). An example network intrusion detection component 704 is further configured to detect the intrusion event 712 in response to a communication frequency description 806 (e.g., a communication rate that exceeds an authorized or expected value, a communication rate that is outside of an expected range, and/or sequencing of the communication, such as burst and rest behavior, that is not expected from the source or to the target). An example network intrusion detection component 704 is further configured to detect the intrusion event 712 in response to a communication destination value 808 (e.g., an indication that the communication target is unknown, unauthorized, on a blocked list, unexpected, or the like). An example network intrusion detection component 704 is further configured to detect the intrusion event 712 in response to a communication payload value 810 (e.g., the payload or information content of a message is larger than expected, formatted incorrectly, includes values that are out-of-range, etc.).

An example intrusion response operation 710 includes providing a notification in response to the detected intrusion event, for example to a selected group of users, external devices, end points, or the like. In certain embodiments, the intrusion response operation 710 includes providing the notification in response to a severity, impact, and/or scope of the detected intrusion event 712, for example providing a more comprehensive and/or more broadly distributed notification in response to a severe attack, and/or an attack that could potentially affect a large number of vehicles and/or a large number of systems on a vehicle. The example notification may include additional information, and/or subsequent notifications (e.g., as an escalation operation), may include additional information. Referencing FIG. 9, example and non-limiting content for a notification 902 include one or more of: an intrusion event severity 904 (e.g., indicating the severity of the intrusion according to intrusion type, for example improper data collection may have a different impact than spoofing control commands; and/or according to overall impact, for example depending upon the impact of the communications to control operations, network capability, compromising data, etc.); a notification target 906 (e.g., end points, external devices, specific personnel or accounts, etc. to be notified, and/or the notification method such as text, e-mail, a message on a user interface, etc.); a severity description 908 (e.g., allowing for differentiation of managed intrusion events relative to unmanaged intrusion events, etc.); an intrusion type 910 (e.g., identifier of an intrusion type such as data spoofing, data scraping, attempts to install code, DDOS attack, etc.); an intrusion confidence value 912 (e.g., a categorical and/or quantitative description of a confidence that a suspected event is an actual attack, and/or that aspects such as severity, type, and/or success of the attack is properly understood and described); an intrusion source value 914 (e.g., an end point and/or external address that is the source of the attack, and/or that is the source of an intrusive communication); and/or an intrusion destination value 916 (e.g., an end point and/or external address that is the target for the attack, and/or that is the destination for an intrusive communication).

An example intrusion response operation 710 includes blocking a communication source in response to the detected intrusion event 712, for example adding a communication source to a blocked list, removing the communication source from an authorized or allowed list, or the like. An example controller 104 includes the intrusion response operation 710 communicating an intrusion source value to a vehicle cloud communication controller 526, for example a controller that manages external communications between end points of the vehicle and external devices, where the vehicle cloud communication controller 526 can then block communications between any end point on the vehicle and the external address indicated by the intrusion source value. In certain embodiments, the intrusion source value may indicate an end point on the vehicle, where the controller 104 blocks communications from the end point (e.g., where an end point has been compromised, and/or is spoofed into providing communications that are not authorized). In certain embodiments, intrusion response operation 710 includes providing a notification to the vehicle cloud communication controller, for example to pass the notification along to a cloud controller and/or other external device, and/or allowing the vehicle cloud controller to adjust permissions, external communications, or the like, in response to the notification.

An example vehicle cloud communication controller 526 interprets a communication policy 714, and the network monitoring component 702 interprets the network communications 708 in response to the communication policy 714. For example, an intrusion event 712 may lead to an update of the communication policy 714, which adjusts which network communications 708 are monitored by the network monitoring component 702, allowing the controller 104 to adjust monitoring operations based on detected or suspected intrusion events 712. In another example, the communication policy 714 may be passed to the vehicle cloud communication controller 526 to implement monitoring operation updates, for example due to an updated risk assessment apart from the vehicle, due to a detected intrusion event 712 in an offset vehicle, and/or to capture known risk information for a new vehicle, an upgraded vehicle, a serviced vehicle, or the like.

An example vehicle cloud communication controller 526 interprets a communication policy 714, and the network intrusion detection component 704 detects the intrusion event 712 in response to the communication policy 714. For example, an intrusion event 712 may lead to an update of the communication policy 714, which adjusts the permissions, blocked/allowed sources and/or destinations, expected content of messages, expected communication rates of messages, etc., for evaluation by the network intrusion detection component 704. In another example, the communication policy 714 may be passed to the vehicle cloud communication controller 526 to implement intrusion event detection operation updates, for example due to an updated risk assessment apart from the vehicle, due to a detected intrusion event 712 in an offset vehicle, and/or to capture known risk information for a new vehicle, an upgraded vehicle, a serviced vehicle, or the like.

An example vehicle cloud communication controller 526 interprets a communication policy 714, and the network intrusion detection component 704 detects the intrusion event 712 in response to the communication policy 714. For example, an intrusion event 712 may lead to an update of the communication policy 714, which adjusts the intrusion event response operations 710 to be performed by the intrusion response component 706, for example changing data to be collected, notifications to be provided, actions to be performed based on unknown and/or heuristically risky communications (e.g., communications dealing with control operations, sensitive data, high rate communications, etc.). In another example, the communication policy 714 may be passed to the vehicle cloud communication controller 526 to implement intrusion event response operation 710 updates, for example due to an updated risk assessment apart from the vehicle, due to a detected intrusion event 712 in an offset vehicle, and/or to capture known risk information for a new vehicle, an upgraded vehicle, a serviced vehicle, or the like.

An example vehicle cloud communication controller 526 interprets at least one of a new communication policy or an updated communication policy, and updates the communication policy 714 in response to the at least one of the new communication policy or the updated communication policy. A new communication policy 714 may be provided, for example by an external device, as a separate (e.g., appended) policy and/or as a new replacement policy. In certain embodiments, a new communication policy 714 may be implemented for a period of time, for a number of operations (e.g., vehicle on/off cycles), or the like, and/or may be implemented continuously until replaced.

Operations herein to adjust monitoring of network communications, detection of intrusion events, and/or adjusting intrusion event response operations in response to a policy change or update, may additionally or alternatively be performed in response to an automated intrusion response. An example intrusion event response operation 710 includes an operation to request and/or receive an updated policy, to request and/or receive an updated automated intrusion response, and/or to receive a confirmation (e.g., from a controller 104B on a cloud server) that an updated policy and/or automated intrusion response is not indicated based on the intrusion event 712.

Referencing FIG. 10, an example system 1000 includes a controller 104 having an intrusion monitoring component 1002 configured to interpret intrusion communications 1010 from a number of vehicles, each one of the vehicles at least selectively communicatively coupled to the controller, and each one of the vehicles having a plurality of network zones each having a plurality of end points. The example controller 104 includes an intrusion processing component 1004 configured to identify an intrusion risk 1014 in response to the intrusion communications 1010, and an intrusion reporting component 1006 configured to provide an intrusion overview communication 1012 in response to the intrusion risk 1014. Example intrusion communications 1010 include, without limitation, one or more of: notifications 222 (and/or alerts) from vehicle controllers indicating that an intrusion event or attempt has occurred on that vehicle; network communications from vehicle controllers that may be utilized by the intrusion processing component 1004 to determine and/or infer that intrusion events and/or attempts have occurred on one or more of the vehicles; and/or other information, such as applications, flows, end points, or the like that are affected by the intrusion events and/or attempts for a vehicle. Without limitation to any other aspect of the present disclosure, any information available as a network communication, notification, and/or alert as described herein may be utilized as an intrusion communication 1010. In certain embodiments, operations of the controller 104 may be utilized to adjust the intrusion communications 1010, for example by providing appropriate policies, data collection requests, and/or automated intrusion operations, to vehicles thereby adjusting the information provided as an intrusion communication 1010. The utilization of the intrusion communication 1010 allows for distributed detection and responses to intrusion events, for example with a first layer of defense on the vehicle, and a second layer of defense in a cloud server or supporting external device, allowing for the second layer of defense to utilize more sophisticated detection techniques (e.g., with computing power not limited as in a mobile application), to apply broader expertise to detection and/or response planning (e.g., providing an interface with notifications to appropriate users across a spectrum of knowledge areas), and/or to aggregate information across vehicles allowing for earlier, lower impact, and/or higher confidence detection and response to intrusion risks 1014 than is available from the data of a single vehicle.

An example intrusion reporting component 1006 provides the intrusion overview communication 1012 to an intrusion management user interface 1008. The example intrusion management user interface 1008 may interact with a web portal, mobile application, application on computing device such as a laptop, desktop, or the like, allowing for: convenient access to the intrusion overview communication 1012; providing visualizations of intrusion aspects (e.g., types, severity, impact, frequency, etc.) to a user; receipt of notifications, alerts, and/or underlying data related to intrusion events and/or attempts; and/or for managing intrusion responses, such as confirming and/or configuring response operations (e.g., notifications, policy updates, data collection updates, automated intrusion response updates, etc.). Referencing FIG. 11, an example intrusion overview communication 1012 includes an intrusion report 1102, which may include information such as: an intrusion severity value 1104, an intrusion scope value 1106, an intrusion confidence value 1108, an intrusion type value 1110, and/or an intrusion impact description 1112. The utilization of the intrusion report 1102 allows a user to quickly determine the nature and severity of an intrusion event, whether the event is being managed and/or needs to be escalated, the impact of the intrusion event (e.g., financial, reputational, regulatory, etc.), and which vehicles, vehicle features, and/or vehicle flows are potentially affected by the intrusion event.

Referencing FIG. 12, an example and non-limiting intrusion management user interface 1008 is schematically depicted. The example interface 1008 includes an intrusion management dashboard 1201 provided to the intrusion management user interface 1008. The example dashboard 1201 is accessible to a user, having sufficient permissions, to access a hosting server for the intrusion management user interface 1008, for example a cloud server. The information on the dashboard 1201 is a non-limiting example, and may be configured according to a role of the user, an entity associated with the user, permissions associated with the user, and/or preferences indicated by the user. The example dashboard 1201 is depicted with example visualizations for various categories of information, but may additionally or alternatively provide descriptions for such data, such as text descriptions, supporting data files, summaries and/or statistical analyses of the data elements, or the like. The example dashboard 1201 includes an intrusion severity visualization 1202, which may include a severity according to intrusion type, end points affected, flows affected, likelihood to incur a data protection risk, likelihood to incur a vehicle control risk, an indexed severity value (e.g., from formula, weighted rating system, etc.). An example intrusion severity visualization 1202 may be Pareto analysis interface, for example allowing a user to sort according to a group of highest risk events, etc. The example dashboard 1201 includes an intrusion scope visualization 1204, for example showing vehicle groups, vehicle features, flows, etc. that are potentially affected by a given intrusion event. In certain embodiments, an intrusion scope visualization 1204 may be organized by intrusion event (e.g., which vehicles are affected), by vehicle groups (e.g., which intrusion events are potentially affecting a selected vehicle group), or by any other organizing dimension. The example dashboard 1201 includes an intrusion confidence visualization 1206, for example providing a categorical and/or quantitative description of a confidence that a detected event is an actual intrusion (or not an intrusion), and/or a confidence related to any aspect thereof (e.g., typing, severity, impact, scope, etc.). The example dashboard 1201 includes an intrusion type visualization, for example providing the user with a convenient overview of the type of intrusion events related to a selected group of vehicles, selected features, selected components (e.g., vehicles having updated ambient sensor ABC), or the like. The example dashboard 1201 includes an intrusion impact visualization 1210, for example providing a convenient overview of the impact of a particular intrusion event on a group of vehicles, an entity (e.g., a fleet owner), or the like, where impacts may be operational (e.g., affecting ability of vehicles to perform mission functions), service (e.g., due to service events driven by the intrusion event), regulatory (e.g., data loss and/or breach risks), or the like.

The example dashboard 1201 includes selection tools 1212, for example allowing the user to select vehicles of interest, entities of interest, geographic regions, vehicle features, vehicle flows, and/or intrusion events of interest (e.g., identified events, events of a given type, events of a given impact, etc.). The example dashboard 1201 includes a filter/sort/query tool 1214, allowing for the user to perform filtering, sorting, and/or query operations for selected vehicles, intrusion events, etc. The example dashboard 1201 provides a group alert tool 1218 allowing for the user to create and/or adjust notifications and/or alerts, including potentially alert escalation criteria and actions, for example to configure notifications for intrusion events according to severity, impact, type, scope, etc., and/or to tailor notifications and/or alerts according to related entities (e.g., by manufacturer, fleet owner, etc). In certain embodiments, the group alert tool 1218 further provides a group alert description, for example allowing the user to review the configuration of notifications and/or alerts, including the content, location, timing, and/or targets for alerts and/or notifications.

The example dashboard 1201 includes an action tool 1216 interface. In certain embodiments, the dashboard 1201 includes and/or allows access to a security command center interface, for example utilizing the action tools 1216 in the example of FIG. 12, allowing the user to perform operations such as: adjusting a blocked/allowed source list 1302 (reference FIG. 13); adjusting a blocked/allowed target list 1304; adjusting a group alert description 1306; and/or creating/configuring an escalation plan 1308. An example dashboard 1201 includes providing interactive data in response to a selection of an element of the intrusion overview communication 1012, for example responding to a user selection of a visualization 1202, 1204, 1206, 1208, 1210 to provide a detail of the data underlying the visual, such as a table of data, specific data file from a vehicle, output file from a detection component, an enhanced visual based on the selected aspect of the visualization 1202, 1204, 1206, 1208, 1210, etc.

An example intrusion processing component 1004 is further configured to identify the intrusion risk 1014 by analyzing the intrusion communications 1010, and detecting an intrusion event in response to the analysis. An example intrusion processing component 1004 is further configured to detect the intrusion event in response to the analysis of intrusion communications from a plurality of the vehicles, for example where intrusion communications 1010 from a number of vehicles are aggregated to determine that an intrusion event has occurred—such as when sparse intrusive communications on a single vehicle do not necessarily indicate that an intrusion is being attempted, where sourcing information is scattered when viewed from the perspective of a single vehicle but more clear for a group of vehicles, and/or where the sample size of a group of vehicles makes statistical determinations and/or pattern recognition determinations more clear relative to the data available from a single vehicle. An example analysis of intrusion communications includes performing a pattern recognition operation, for example looking at patterns in time, communication sequencing, message sizes, communication attempts, or any other type of pattern in the intrusion communications 1010, and determining the intrusion risk 1014 in response to the pattern recognition operation. An example analysis of intrusion communications includes performing a communication source analysis, a communication target analysis, a communication frequency analysis, and/or a communication content analysis, and determining the intrusion risk 1014 in response to one or more of these.

Referencing FIG. 14, an example system 1400 includes a controller 104 having a network monitoring component 702 configured to interpret network communications 708 associated with at least one network zone of a vehicle having a number of network zones, each having a number of end points thereon. The example controller 104 includes a network intrusion detection component 704 configured to detect an intrusion attempt 1406 in response to the network communications 708, and an intrusion response component 706 configured to perform an intrusion prevention operation 1404 in response to the detected intrusion attempt 1406. Example and non-limiting intrusion prevention operations 1404 include operations such as adjusting a blocked/allowed source list, and/or adjusting a blocked/allowed target list.

An example network intrusion detection component 704 is further configured to interpret an automated intrusion response 1402 in response to the detected intrusion attempt 1406 (e.g., received from interactions of a user with a intrusion management user interface 1008), and to update the operations to detect the intrusion attempt in response to the automated intrusion response 1402. An example network intrusion response component 706 is further configured to interpret an automated intrusion response 1402 in response to the detected intrusion attempt 1406, and wherein the intrusion response component 706 is further configured to update the intrusion prevention operation 1404 in response to the automated intrusion response 1402.

Referencing FIG. 15, an example automated intrusion response 1402 includes a workflow to be performed on the controller 104. Example and non-limiting workflows 1501 include one or more operations such as: performing an intrusion attempt detection 1502 (e.g., operations defined by a user, expert system, artificial intelligence, and/or machine learning component, to detect an intrusion attempt); performing an intrusion attempt confirmation 1504 (e.g., operations defined as in 1502, to develop information to confirm that the intrusion attempt was made or is being made, and/or that the intrusion attempt was likely to have been made or is likely being made, for example checking other systems or communications that are likely to also be affected by the intrusion attempt, confirming that communications from a suspected source fit a pattern consistent with intrusive communications, etc.); creating and/or adjusting an intrusion notification scheme 1506; performing an intrusion attempt block 1508 operation (e.g., adding a communication source to a blocked list, disabling communications to a target end point on the vehicle, removing permissions from an end point, application, flow, etc. that otherwise enable the intrusion attempt, etc.); performing an intrusion attempt characterization 1510 operation (e.g., gathering additional data from the vehicle, and/or stored data from a cloud server, that may develop information about the intrusion attempt, what type of intrusion the attempt is likely to represent, systems, flows, end points, etc. that are implicated by the intrusion, confirmation of aspects of the vehicle affected, for example to determine which other vehicles of a group are likely to be affected, etc.); and/or performing an intrusion attempt mitigation 1512 operation (e.g., providing and/or escalating notifications and/or alerts for users of an intrusion management user interface 1008, reducing impacts of the intrusion such as limiting or re-routing network traffic, moving control operations between available ECUs on the vehicle, implementing a control limit such as a maximum speed or power value, etc.).

An example controller 104 further includes a vehicle cloud communication controller 526, where the vehicle cloud communication controller 526 is configured to manage communications between: 1) each one of the number of end points on the number of network zones, and 2) external devices at least selectively communicatively coupled to the vehicle. The example vehicle cloud communication controller 526 is further configured to interpret an automated intrusion response 1402, and the intrusion detection component 704 is further configured to update operations to detect the intrusion attempt 1406, and/or to update the intrusion event prevention operation 1404, in response to the automated intrusion response 1402. The automated intrusion response 1402, where present, may be provided by an external device (e.g., a cloud server, service tool, manufacturing tool, etc.). In certain embodiments, the automated intrusion response 1402 may be present on the controller 104, and operations to interpret the automated intrusion response 1402 include enabling or activating the automated intrusion response 1402 in response to the detected intrusion attempt 1406.

Referencing FIG. 16, an example system 1600 includes a controller 104 having an intrusion monitoring component 1002 configured to interpret intrusion communications 1010 from a number of vehicles, each one of the vehicles at least selectively communicatively coupled to the controller 104, and each one of the vehicles having a number of network zones each having a number of end points. The example controller 104 further includes an intrusion processing component 1004 configured to identify an intrusion attempt 1406 in response to the intrusion communications 1010, and an intrusion prevention component 1602 configured to provide an automated intrusion response 1606 and/or a communication policy 714, to at least one of the number of vehicles, in response to the identified intrusion attempt 1406. In certain embodiments, the automated intrusion response 1606 and/or communication policy 714 is provided to vehicle(s) as a vehicle communication 1604. In certain embodiments, the controller 104 of FIG. 16 is positioned, in whole or part, on a cloud server that is at least selectively in communication with one or more vehicles of interest, the vehicles of interest configured to implement the communication policy 714 and/or automated intrusion response 1606, for example utilizing circuits, controllers, and/or components as set forth throughout the present disclosure.

An example intrusion prevention component 1602 is configured to implement an intrusion management interface 1008, and to provide the communication policy 714 and/or automated intrusion response 1606 in response to user interactions with the intrusion management user interface 1008. Example and non-limiting automated intrusion responses 1606 include operations to prevent an intrusion and/or operations to mitigate an intrusion. In certain embodiments, aspects of the automated intrusion response 1606 may be operable as a workflow executable by a controller of the vehicle, for example including workflows such as those set forth in FIG. 15 and the related description.

An example communication policy 714 includes a policy of any type as set forth throughout the present disclosure, including at least an updated policy, an add-on policy, and/or a new policy. The example communication policy 714 may include an aspects to prevent an intrusion (e.g., adjusting permissions, disabling communications or end points, adding sources and/or destinations to a blocked list, etc.), to mitigate an intrusion (e.g., actions to reduce the consequences of a potential intrusion, such as reducing network traffic, limiting access to critical flows, applications, ECUs, etc.), to develop confirmation and/or characterization information relative to an intrusion (e.g., collecting additional data to develop further knowledge about the potential intrusion, and/or to confirm aspects of the intrusion and/or intrusion source), and/or to improve detection operations and/or response operations to a future intrusion having a similar aspect (e.g., a similar intrusion mechanism, intrusion communication scheme, source and/or destination, etc.). Referencing FIG. 17, example communication policy 714 elements include one or more of: blocked/allowed source values 1702; blocked/allowed target values 1704; a communication payload value 1706 (e.g., payloads of messages that tend to indicate that an intrusion is being attempted, that are consistent with an intrusion attempt—such as data that is static (e.g., indicating that an artificial source may be present for the data) and/or out of range (e.g., indicating that a source for the data may not be legitimate)); and/or a communication frequency description 1708 (e.g., message timing, frequency, or the like that indicates the message may not have a legitimate source, frequency characteristics of the message that is not expected, for example where a message may be expected to change rates with another aspect of the system, such as a motor speed, and/or where dynamic response of the message is not consistent with expected or modeled values—for example based on message variability, fundamental frequencies of changes, unexpected ramp rates, unexpected statistical variation such as standard deviations over a period of time, correlation or a lack thereof with other messages, etc.).

The example system 1600 provides a convenient interface to apply sophisticated analysis to detect, confirm, mitigate, and/or prevent intrusion operations, to get notifications from vehicles, and/or to implement improved detection, confirmation, mitigation, and/or prevention operations on selected vehicles quickly, conveniently, and with a high confidence that vehicles have implemented the updates. Further, the intrusion management user interface 1008 allows users to readily confirm the status of selected vehicles, to track trends and impacts of intrusion operations, and to improve the knowledge of intrusion operations beyond that which would be available by considering single vehicles individually. Additionally, the system 1600 is capable to perform such operations regardless of the configuration of the vehicles, including which end points are coupled to which networks on the vehicle, which versions of components are installed on the vehicle, or the like. Accordingly, the system 1600, and systems and other embodiments throughout the present disclosure, are robust to achieving the intrusion detection, confirmation, mitigation, and/or prevention in a highly variable environment, for example with vehicle configurations changing with model year, trim package, performance package, after servicing, after upgrades, and/or after recalls—including in a mixed environment where some vehicles have received scheduled upgrades or recalls, and other vehicles have not.

In certain embodiments, an identified intrusion attempt may occur on a first vehicle, with a the intrusion response being performed on other vehicles, in addition to or instead of the first vehicle (e.g., a first vehicle of a fleet has an intrusion event, and other vehicles of the fleet are updated to detect, prevent, and/or mitigate the same or similar intrusion events). In certain embodiments, an identified intrusion attempt is identified from intrusion communications 1010 from several vehicles, for example where the intrusion communications 1010 from one of the vehicles may not have enough information to confirm that the intrusion attempt has occurred. In certain embodiments, an identified intrusion attempt is detected and/or suspected based on intrusion communications 1010 from a single vehicle, and the identified intrusion attempt is further confirmed or characterized from intrusion communications 1010 from other vehicles, in addition to or alternatively to the intrusion communications 1010 from the first vehicle.

In certain embodiments, the intrusion processing component 1004 identifies the intrusion attempt 1406 by performing at least one operation such as: aggregating at least one aspect of the intrusion communications 1010 (e.g., from several vehicles, from an entire group of vehicles, from multiple controllers on a vehicle, etc.); performing a statistical analysis of at least one aspect of the intrusion communications 1010 (e.g., to confirm anomalous communications, to determine that characteristics of a set of messages are out of range, inconsistent with expectations, etc.); and/or performing a pattern recognition operation of at least one aspect of the intrusion communications (e.g., identifying a mode switch, change in dynamics, change in average state, etc., of a message or set of messages). Referencing FIG. 18, example and non-limiting intrusion communications 1010 that may be utilized to detect, confirm, and/or characterize an intrusion attempt include communications such as: intrusion notification value(s) 1802 (e.g., notifications that an intrusion or attempt has been detected on a vehicle, for example by detection operations performed on a controller of the vehicle); intrusion alert value(s) 1804 (e.g., alerts that an intrusion or attempt has been detected on a vehicle); a control parameter 1806 (e.g., any control parameter such as set points, sensor values, intermediately determined values, error values, state values, etc., for example to be analyzed to ensure those values are legitimately sourced and/or to confirm whether control operations are being affected by an intrusion); network communication values 1808 (e.g., to detect anomalous messages, to determine a source and/or destination of messages, to determine whether unauthorized communications are present on a network, and/or to parse network message to determine whether an intrusion has occurred, to confirm an intrusion, to characterize an intrusion, and/or to determine an impact of the intrusion on operations of the vehicle); and/or a network monitoring value 1810 (e.g., a value indicating network function, such as latency, traffic levels, etc., and/or whether network traffic is within expectations or anomalous, including verifying data integrity for mirrored ports, message metadata, or the like).

Referencing FIG. 19, an example system 1900 includes a controller 104 having a log monitoring component 1902 configured to interpret a log corpus 1912 associated with at least one end point of a number of end points distributed on a number of network zones of a vehicle, and a log analysis component 1904 configured to detect a risk event 1916 in response to the log corpus 1912. The example controller 104 further includes a risk response component 1906 configured to perform a risk response operation 1914 in response to the detected risk event 1916. The example log corpus 1912 may be associated with a single end point (e.g., an ECU of the vehicle), with more than one end point (e.g., several ECUs of the vehicle, which may be related or not, for example where the log corpus 1912 is formed from logs generated by several ECUs and combined for convenience, and/or because the ECUs are related in some manner, such as similar functions, operating as a part of a vehicle application or flow, etc.). In certain embodiments, the log corpus 1912 includes log information developed separately from an end point, such as network monitoring information, flow monitoring information, or the like.

Referencing FIGS. 20-25, several example and non-limiting embodiments of a log corpus 1912 are schematically depicted. FIG. 20 depicts a log corpus 1912 including first end point log data 2002 and second end point log data 2004, for example where the log corpus 1912 is formed from log data for two end points. The example of FIG. 21 includes a log corpus 1912 formed from a portion of the log data for each of two end points. The example of FIG. 22 includes a log corpus 1912 corresponding to a single end point. The example of FIG. 23 includes a log corpus 1912 corresponding to a portion of log data from a single end point. The example of FIG. 24 depicts a log corpus 1912 formed from a portion of log data from a first end point, and the log data of a second end point. The example of FIG. 25 depicts a log corpus 1912 formed from a portion of log data from a first end point, and further from network monitoring log data 2502, and further from flow monitoring log data 2504. The log data may be generated from any log on an ECU of the vehicle, including for example fault logs, monitoring logs, or the like, and/or from any log data off the vehicle utilizing vehicle data, for example a circuit, controller, processor, component, or the like that monitors vehicle network communications, flows on the vehicle (e.g., to determine proper operation of vehicle functions related to the flow), applications on the vehicle, or the like, and/or simply off-vehicle data that would be stored on the vehicle but is stored off the vehicle for convenience, to reduce storage utilization on the vehicle, or the like.

Referencing FIG. 26, example and non-limiting data that may be included in the log corpus 1912 is schematically depicted. An example includes network monitoring parameters 2602 (e.g., network communications, utilization, message counts, message statistics, etc.); network communications 2604 (e.g., raw or processed network messages, including headers, payloads, etc., and which may be from any network on the vehicle); event detection value(s) 2606 (e.g., including intrusion and/or intrusion attempt events such as set forth throughout the present disclosure, but which may additionally or alternatively include any event detections such as event detection from trigger determinations in automated vehicle response operations, state values from any controller of the vehicle, and/or any event detection operations by any controller of the vehicle, including brake engagement, accident detection, rapid acceleration events, maintenance monitoring values, etc.); flow monitoring parameters 2608 (e.g., values monitored to ensure that a flow of the vehicle is performing correctly, when the flow is active, accumulated parameters related to the flow such as time of operation, fuel consumption, energy saved, etc.); flow processing parameters 2610 (e.g., intermediate values utilized to operate a flow of the vehicle, for example parameters that may not be communicated to a network, such as active governors, set points, intermediate state values utilized for the flow, etc., for example values that might be used in engineering to confirm operations, to incrementally improve operations, and/or debug operations); fault codes 2612 (e.g., active fault codes, which may be of any type, including faults that are silent, and/or faults that are utilized to engage an operator lamp, etc.); fault processing values 2614 (e.g., values utilized to determine fault conditions and/or whether a fault code will be set, for example intermediate conditions that, if they persist, may result in the setting or clearing of a fault, but that are not the direct indicator of the fault); operating condition values 2616 (e.g., values from any state determination of the vehicle, such as operating mode, powering mode, on/off/shutdown operating conditions, performance versus economy targets for operation, ambient condition indicators, and/or any control modes that are active or inactive due to these—such as a high altitude operating condition, etc.); ECU status values 2618 (e.g., indicators that an ECU is operating properly, has lost connection, is stuck in a limited operating mode, etc.); and/or data string values 2620 (e.g., any data string from any message, including for example data strings appearing in a message header, message payload, combinations of these and/or combinations of these between messages—for example allowing for an artificial intelligence and/or machine learning component to determine any data values that may indicate a risk event 1916, and that may not be readily apparent—for example a failing sensor may send out a specific set of data that corresponds to a data string that can be correlated to an imminent failure of the sensor, an ECU failure may send a sequence of messages that result in a predictable data string appearing in the log corpus 1912, certain data strings may be generated by a sequence of messages, state conditions, etc. that correspond to and/or precede a risk event 1916, etc.).

An example risk response component 1906 performs the risk response operation 1914 by implementing a log analysis user interface 1908 in response to the detected risk event 1916, for example by providing a notification, visualization, event description, or the like on the log analysis user interface 1908 including information utilized to detect, confirm, and/or analyze the detected risk event 1916. An example risk response component 1906 performs one or more operations such as: providing a visualization on the log analysis user interface 1908 in response to the detected risk event 1916, providing a risk analysis interface on the log analysis user interface 1908 in response to the detected risk event 1916, providing a notification on the log analysis user interface 1908 in response to the detected risk event 1916, and/or providing a suggested action executable object (e.g., an object providing a suggested action, and allowing the user to accept, modify, and/or execute the suggested action—for example where the action includes a notification, alert, configurable report, automated vehicle response, adjustment to a policy, etc., based on the detected risk event 1916, for example with suggested actions based on previous responses to the risk event, as set up by an expert system, and/or a suggested action to develop more data related to the risk event). An example risk response component 1906 performs one or more operations such as: providing a risk severity description on the log analysis user interface 1908 in response to the detected risk event 1916; providing a risk type description on the log analysis user interface 1908 in response to the detected risk event 1916; or providing a risk confidence description on the log analysis user interface 1908 in response to the detected risk event 1916.

Referencing FIG. 27, an example log analysis user interface 1908 is schematically depicted, including example aspects that may be implemented on the log analysis user interface 1908. The example log analysis user interface 1908 includes a risk event notification 2702, for example providing a convenient location for the user to reference active and/or recent notifications, alerts, or the like, for example notification of recent detected risk events 1916. The example log analysis user interface 1908 includes a risk severity visualization 2704 (e.g., determined based upon systems, applications, ECUs, flows, or the like affected by the detected risk, and/or effects to vehicle operation, mission, controllability, or the like), a risk scope visualization 2706 (e.g., indicating which vehicles and/or vehicle systems are affected by or related to a risk event 1916, and/or which risk events 1916 are related to which vehicles), a risk confidence visualization 2708 (e.g., determined according to a likelihood and/or certainty that a detected risk event 1916 is an actual risk event, and/or that the risk event 1916 is likely to progress to an actual loss event, etc.), a risk type visualization 2710 (e.g., determined according to any risk type scheme, such as risk to operation, controllability, data loss, compliance and/or regulatory risks, etc.), and a risk impact visualization 2712 (e.g., according to risk impact by any selected measure, such as number of vehicles affected, potential losses due to the risk, potential service events, down time, recall events, etc.). The example of FIG. 27 depicts a number of visualizations, but any one or more of the visualizations may additionally or alternatively include a description, which may be accessible by selecting a visualization, as a tool tip related to a visualization, presented instead of a visualization, and/or selectable between the visualization and the description. In certain embodiments, the visualizations and/or descriptions depicted may be presented according to a user role, related user entity, which visualizations or descriptions are likely to be of the most interest to the user, and/or according to user selections or preferences.

The example log analysis user interface 1908 includes selection tools 2714, for example defining related vehicles, geographic regions, risk events of interest, log sources to be utilized for the analysis, etc. The example log analysis user interface 1908 includes filter/sort/query tools 2716, allowing for the user to filter, sort, and perform queries on the log analysis information (e.g., vehicles, vehicle groups, risk events, and/or raw or processed log files). The example log analysis user interface 1908 includes a create/configure group alert tool 2722, allowing for the user to set up notifications and/or alerts, and/or escalation behaviors (e.g., for persistent risks, uncleared or unresolved risks, for changes in risk severity, and/or selectable escalation according to user interactions), including recipients of notifications, and/or notification methods (e.g., text, e-mail, notifications to the log analysis user interface, etc.). The example log analysis user interface 1908 further includes an action tools 2720 object, allowing the user to perform a number of actions conveniently from the log analysis user interface 1908. The information, display, and available operations of the log analysis user interface 1908 are non-limiting examples to illustrate certain aspects of the present disclosure. In certain embodiments, any features, operations, options, or the like as described in relation to the intrusion management dashboard 1201 are also available to the log analysis user interface 1908, and vice versa. In certain embodiments, the intrusion management dashboard 1201, intrusion management user interface 1008, and/or the log analysis user interface 1908 may be operated similarly, provided by a same controller, and/or operate as a same web portal, mobile application, and/or application operated from a user device (e.g., a laptop, tablet, and/or desktop computing device).

Referencing FIG. 28, an example risk analysis interface, for example accessed using a risk analysis tool 2718, is schematically depicted. The risk analysis interface is accessed, in the example, by the user selecting the risk analysis tool 2718, although any other operations to present a risk analysis interface may be utilized. The example risk analysis information may be utilized to evaluate a particular risk or group of risks, and/or to build a risk event detection operation that can be utilized by a log analysis component 1904 (e.g., on vehicle, in the cloud, and/or distributed between these) to detect risk events 1916. The example risk analysis interface includes a pattern analysis component 2802, allowing the user to access a visualization and/or description illustrating a detected pattern in the log corpus 1912 that was utilized to detect a risk event 1916, and/or to build a pattern recognition operation to detect risks going forward. For example, the user can build a parameter index (e.g., weighted values of a mix of parameters, transformed values for parameters, and/or detection thresholds for parameters and/or parameter indices), set thresholds for the parameter index to determine that the pattern criteria are met, and implement the pattern analysis operation for utilization by a log analysis component 1904. In certain embodiments, multiple parameters, sequenced threshold determinations, and/or any other complex monitoring or logic may be implemented for pattern recognition operations. In certain embodiments, the risk analysis interface can import real data, for example from a log corpus 1912, simulated data, or the like, such that the user can reference actual outcomes for the pattern recognition operations, determine whether particular risk events would be detected, or the like. The example risk analysis interface includes a fault tree analysis component 2804, for example allowing the user to access a diagnostic and/or service routine to be implemented based upon the detected risk event 1916, and/or to build a diagnostic and/or service routine for utilization by other users in response to the detected risk event 1916. In certain embodiments, some or all aspects of a diagnostic and/or service routine may be implemented through a policy update (e.g., to collect specified data for diagnostic execution, and/or to perform service operations to adjust network configurations, ECU responsibilities, etc. for the vehicle as a service event), and/or as an automated vehicle response operation (e.g., providing vehicle commands, detection and/or execution triggers, or the like, to be performed as a diagnostic and/or service event). The example risk analysis interface includes an event detection builder 2806, for example providing a convenient interface for a user to implement event detection operations, for example defining trigger criteria, available parameters, and/or allowing for logic operations to build event detections. Event detections from the event detection builder 2806 may be utilized, without limitation, as operations to detect risk events 1916 determined from the log corpus 1912, and/or to detect events related to diagnostic or service operations (e.g., criteria that should be in place before an active diagnostic and/or service operation is performed).

The example risk analysis interface includes a risk event description 2810, for example providing a convenient reference for the user to understand, and/or adjust, aspects of the risk event being analyzed (e.g., when the risk analysis interface is being utilized to analyze a detected risk event 1916) and/or detected (e.g., when the risk analysis interface is being utilized to build a risk event detection 1916 procedure). The example risk analysis interface includes an export data tool 2812, for example allowing detection operations code, analysis views, marked visualizations, or the like, to be sent to a selected user, stored as a usable file, and/or sent to another application (e.g., an application building new policies, data collection routines, and/or automated response operations). The example risk analysis interface includes an export results tool 2814, for example allowing the user to export analysis results or the like, to be sent to a selected user and/or stored as a usable file. The example risk analysis interface includes an export policy tool 2816, for example allowing the user to create and/or export a policy file, for example implementing aspects of a risk event detection 1916 operation and/or a risk response operation 1914, allowing the user to build a low code and/or no code policy that implements planned detection operations, pattern recognition operations, diagnostic operations, and/or service operations, for example according to interactions of the user with the risk analysis interface. The example risk analysis interface includes an export automated response tool 2818, for example allowing the user to create and/or export an automated response operation file, for example implementing aspects of a risk event detection 1916 operation and/or a risk response operation 1914, allowing the user to build a low code and/or no code automated response operation that implements planned detection operations, pattern recognition operations, diagnostic operations, and/or service operations, for example according to interactions of the user with the risk analysis interface. In certain embodiments, implementing one or more aspects of planned detection operations, pattern recognition operations, diagnostic operations, and/or service operations include some aspects that are implemented as policy elements, and some aspects that are implemented as automated response operations, where the risk analysis tool is configured to provide the user with an export operation for both the policy and automated response operation aspects.

Referencing FIG. 29, an example action tool 2720 interface is schematically depicted. The example action tool 2720 interface allows the user to perform operations such as: reviewing and/or implementing suggested actions 2902; configuring and/or implementing notifications 2904; configuring and/or implementing alerts 2906; creating and/or configuration escalations 2908; and/or creating and/or configuring the log corpus 2910 (e.g., determining which logs from which end points should be utilized, and/or any additional data that should be collected as a part of the log corpus 1912).

Referencing FIG. 30, an example risk analysis tool 2718 interface is schematically depicted. The example risk analysis tool 2718 may be accessed on the log analysis user interface 1908, for example as an additional or alternative interface from that depicted in FIG. 28, and/or in response to selections and/or log analysis operations performed on an interface such as that depicted in FIG. 28. The example risk analysis tool 2718 allows the user to perform operations such as: performing a severity analysis 3002 (e.g., referencing affected systems, risk event types, affected vehicles, likely repair or response actions, etc., to determine severity values and/or to understand already defined severity values); an impact analysis tool 3004 (e.g., allowing the user to determine and/or understand an impact of the detected risk event, and/or prospective risk event in the builder mode, for example referencing affected systems, risk event types, affected vehicles, likely repair or response actions, etc.); a scope analysis tool 3006 (e.g., displaying and/or allowing the user to determine affected vehicles, vehicle groups, flows, applications, etc. for the detected and/or prospective risk event, including determining those in the future, for example based upon the systems, flows, features, etc. for future model year vehicles); a detection analysis tool 3008 (e.g., allowing the user to understand and/or configure detection criteria for risk events, including which aspects of the log corpus 1912 are utilized to detect risk events); and/or a scenario analysis tool 3010 (e.g., allowing the user to do projections, simulations of risk event detections, etc., including for any other tools and/or components of the example log analysis interface and/or risk analysis interface).

In certain embodiments, the log corpus 1912 may be stored on the vehicle (e.g., on an end point and/or ECU of the vehicle), in the cloud, and/or in a combination of these, including moving the log corpus 1912 over time, in response to data retention plans, and/or according to available memory storage on the vehicle. Example and non-limiting risk events (e.g., detected risk events 1916) include one or more of: a security event (e.g., detecting an intrusion communication and/or attempt, a potential data breach event, etc.); a hazard event (e.g., an event that may affect an aspect of the vehicle that could present a hazard to persons or property, such as a potential loss of an aspect of vehicle control); a service event (e.g., an event that is likely to require additional diagnostic operations, service operations, and/or maintenance operations); and/or a mission event (e.g., an event that may affect the ability of the vehicle or mobile application to perform the mission, for example providing selectable motive power, performing to rated power and/or acceptable power, etc.). An example risk response component 1906 performs a risk response operation 1914 by providing a communication policy update in response to the detected risk event 1916, and communicates the communication policy update to one or more of: a log analysis user interface 1908 (e.g., for confirmation, adjustment, and/or as a suggestion to a user evaluating a detected risk event 1916); an external device (e.g., a service tool, cloud server, manufacturing tool, as an attachment utilizable by a user accessing the log analysis user interface 1908 using a mobile application); and/or to one or more vehicles, including the original vehicle on which the risk event was detected, and/or to other vehicles that are related (e.g., vehicles that share a characteristic with the original vehicle in a manner that indicates the risk event may be relevant to those vehicles). An example risk response component 1906 performs a risk response operation 1914 by providing an automated vehicle response (e.g., without limitation, reference automated intrusion response 1606) in response to the detected risk event 1916, and communicates the automated vehicle response to one or more of: a log analysis user interface 1908 (e.g., for confirmation, adjustment, and/or as a suggestion to a user evaluating a detected risk event 1916); an external device (e.g., a service tool, cloud server, manufacturing tool, as an attachment utilizable by a user accessing the log analysis user interface 1908 using a mobile application); and/or to one or more vehicles, including the original vehicle on which the risk event was detected, and/or to other vehicles that are related (e.g., vehicles that share a characteristic with the original vehicle in a manner that indicates the risk event may be relevant to those vehicles). In certain embodiments, risk response operations, including policies generated, automated vehicle responses generated, or the like, are tailored to the risk comparison of the target vehicle to receive the policy and/or automated response update, and the original vehicle associated with the detection of the risk event that initiated the update.

An example log analysis component 1904 is further configured to detect the risk event in response to detecting a signal value (e.g., data meeting a trigger criteria) in the log corpus 1912. An example risk response component 1906 is further configured to perform the risk operation by: implementing a log analysis user interface 1908 in response to the detected risk event 1916, and updating the signal value (e.g., adjusting the trigger criteria) in response to user interactions with the log analysis user interface 1908. In a further example, the log analysis component 1904 is further configured to utilize the updated signal value to detect subsequent risk events 1916.

An example log analysis component 1904 is further configured to detect the risk event in response to detecting a pattern value in the log corpus 1912. An example risk response component 1906 is further configured to perform the risk operation by: implementing a log analysis user interface 1908 in response to the detected risk event 1916, and updating the pattern value in response to user interactions with the log analysis user interface 1908. In a further example, the log analysis component 1904 is further configured to utilize the updated pattern value to detect subsequent risk events 1916.

An example log analysis component 1904 is further configured to detect the risk event in response to detecting an operational event value (e.g., a state value on the vehicle, a sensor value on the vehicle, an ambient condition detectable on the vehicle, an administrative operation on the vehicle, etc.) in the log corpus 1912. An example risk response component 1906 is further configured to perform the risk operation by: implementing a log analysis user interface 1908 in response to the detected risk event 1916, and updating the operational event value in response to user interactions with the log analysis user interface 1908. In a further example, the log analysis component 1904 is further configured to utilize the updated operational event value to detect subsequent risk events 1916.

An example log analysis component 1904 is further configured to detect the risk event in response to detecting a message value (e.g., any selected string, text, or group of characters; the presence of selected messages; the content of selected messages, etc.) in the log corpus 1912. An example risk response component 1906 is further configured to perform the risk operation by: implementing a log analysis user interface 1908 in response to the detected risk event 1916, and updating the message value in response to user interactions with the log analysis user interface 1908. In a further example, the log analysis component 1904 is further configured to utilize the updated message value to detect subsequent risk events 1916. Example and non-limiting message values include one or more of: a message source value, a message content value, a message frequency value, and/or a message occurrence value (e.g., the presence or lack of a message, a number of occurrences, etc.).

A number of example procedures are schematically depicted following. Example operations are depicted to illustrate aspects of the procedures for clarity of the description. Individual operations may be omitted, combined in whole or part, divided in whole or part, and/or performed in a different sequence unless an explicit dependency upon other operations is evident. Any procedures set forth herein may be performed, without limitation, by circuits, controllers, components, and/or computing devices as described herein.

Referencing FIG. 31, an example procedure 3100 to perform an intrusion response operation is schematically depicted. The example procedure 3100 includes an operation 3102 to interpret network communications associated with network zone(s) of a vehicle, and an operation 3104 to determine whether an intrusion event is detected. In response to operation 3104 indicating NO, the procedure 3100 returns to operation 3102 to continue monitoring network communications. In response to operation 3104 indicating YES, the procedure 3100 includes operation 3106 to perform an intrusion response operation. An example procedure 3100 includes the operation 3104 determining a risk event, and operation 3106 performing a risk response operation. Referencing FIGS. 32-37, example and non-limiting operations 3106 to perform an intrusion response operation (and/or a risk response operation) are schematically depicted. Referencing FIG. 32, an operation 3106 includes providing a notification in response to the detected event. Referencing FIG. 33, an operation 3106 includes blocking a communication source in response to the detected event. Referencing FIG. 34, an operation 3106 includes creating and/or adjusting a policy in response to the detected event. Referencing FIG. 35, an operation 3106 includes adjusting the interpreted network communications in response to the detected event. Referencing FIG. 36, an example operation 3106 includes adjusting the event detection operations in response to the detected event. Referencing FIG. 37, an example operation 3106 includes adjusting the intrusion response operations in response to the detected event.

Referencing FIG. 38, an example procedure 3800 to provide intrusion overview communications is schematically depicted. The example procedure 3800 includes an operation 3802 to interpret intrusion communications associated with network zones of a vehicle, and an operation 3804 to determine whether an intrusion risk is detected. In response to operation 3804 determining NO, the procedure 3800 returns to operation 3802 to continue monitoring intrusion communications. In response to operation 3804 determining YES, the procedure 3800 includes operation 3806 to provide an intrusion overview communication, for example providing and/or updating a description and/or a visualization on a user interface, and/or updating the intrusion overview communication based on the detected intrusion risk.

Referencing FIG. 39, an example operation 3806 includes providing an intrusion report to an intrusion management user interface. Referencing FIG. 40, an example operation 3804 includes analyzing intrusion communications to detect the intrusion event (e.g., where the intrusion communications provide the data by which the intrusion event is detected, in contrast to intrusion communications that explicitly flag the intrusion event).

Referencing FIG. 41, an example procedure 4100 for performing an intrusion prevention operation is schematically depicted. The example procedure 4100 includes an operation 4102 to interpret network communications associated with network zones(s) and/or end points of a vehicle, and an operation 4104 to determine whether an intrusion attempt is detected. In response to operation 4104 indicating NO, the example procedure 4100 returns to operation 4102 to continue monitoring network communications. In response to operation 4100 indicating YES, the example procedure 4100 includes operation 4106 to perform an intrusion prevention operation.

Referencing FIG. 42, an example operation 4106 includes adjusting a blocked/allowed source list. Referencing FIG. 43, an example operation 4106 includes adjusting a blocked/allowed target list. Referencing FIG. 44, an example operation 4106 includes interpreting an automated intrusion response (and/or a communications policy), and updating the operations to detect an intrusion attempt in response to the automated intrusion response (and/or communications policy). Referencing FIG. 45, an example operation 4106 includes interpreting an automated intrusion response (and/or a communications policy), and updating the intrusion prevention operations in response to the automated intrusion response (and/or communications policy).

Referencing FIG. 46, an example procedure 4600 for performing an intrusion prevention operation is schematically depicted. In addition to the procedure 4100, procedure 4600 includes an operation 4602 to determine whether an updated automated response (and/or communications policy) has been received. In response to operation 4602 indicating NO, the procedure 4600 progresses to operation 4102. In response to operation 4602 indicating YES, the procedure 4600 includes operation 4604 to update the intrusion prevention operations in response to the updated automated response (and/or communications policy).

Referencing FIG. 47, an example procedure 4700 for performing an intrusion prevention operation is schematically depicted. In addition to the procedure 4100, procedure 4700 includes the operation 4602 to determine whether an updated automated response (and/or communications policy) has been received. In response to operation 4602 indicating NO, the procedure 4700 progresses to operation 4102. In response to operation 4602 indicating YES, the procedure 4700 includes operation 4702 to update the intrusion attempt detection operations in response to the updated automated response (and/or communications policy).

Referencing FIG. 48, an example procedure 4800 for providing an automated intrusion response and/or communication policy to a vehicle is schematically depicted. The example procedure 4800 includes an operation 4802 to interpret intrusion communications from a number of vehicles, and an operation 4804 to determine whether an intrusion attempt has been identified. In response to operation 4804 indicating NO, the procedure 4800 returns to operation 4802 to continue monitoring the intrusion communications. In response to operation 4804 indicating YES, the procedure 4800 includes an operation 4806 to provide an automated intrusion response and/or communication policy to a vehicle, for example to one of the monitored vehicles and/or another related vehicle.

Referencing FIG. 49, an example procedure 4900 for providing an automated intrusion response and/or communication policy to a vehicle is schematically depicted. In addition to procedure 4800, procedure 4900 includes an operation 4902 to implement an intrusion management user interface, and to process user interactions with the intrusion management user interface. The example operation 4902 allows for a user to confirm, configure, modify, and/or build the automated intrusion response and/or communication policy to be utilized in operation 4806.

Referencing FIG. 50, an example operation 4804 includes an operation 5002 to aggregate aspects of the intrusion communications (e.g., from multiple vehicles, and/or from multiple data sets from a single vehicle), and operation 5004 to identify an intrusion attempt in response to the aggregate aspects of the intrusion communications. Referencing FIG. 51, an example operation 4804 includes an operation 5102 to perform a statistical analysis on intrusion communications, and an operation 5104 to identify an intrusion attempt in response to the statistical analysis (e.g., based on variability, statistical outliers, exceptionally average values, etc.). Referencing FIG. 52, an example operation 4804 includes an operation 5202 to perform a pattern recognition operation on aspects of the intrusion communications, and an operation 5204 to identify an intrusion attempt in response to the pattern recognition operation.

Referencing FIG. 53, an example procedure 5300 to perform a risk response operation is schematically depicted. The example procedure 5300 includes an operation 5302 to interpret a log corpus associated with end points on a vehicle having a number of network zones, and an operation 5304 to determine whether a risk event is detected analyzing the log corpus. In response to operation 5304 indicating NO, the procedure 5300 returns to operation 5302 to continue monitoring the log corpus. In response to operation 5304 indicating YES, the procedure 5300 includes operation 5306 to perform a risk response operation.

Referencing FIGS. 54-61, example operations 5306 to perform a risk response operation are schematically depicted. The example operations 5306 may be applied to intrusion event detections and/or intrusion attempt detections. Referencing FIG. 54, an example operation 5306 includes an operation 5402 to implement a log analysis user interface, and operation 5404 to provide a visualization, notification, fault analysis interface, and/or a suggested action on the log analysis user interface in response to the detected risk event. Referencing FIG. 55, an example operation 5306 includes an operation 5402 to implement a log analysis user interface, and operation 5502 to provide a severity description, risk type description, and/or a risk confidence description, on the log analysis user interface in response to the detected risk event. Referencing FIG. 56, an example operation 5306 includes an operation 5402 to implement a log analysis user interface, and operation 5602 to provide a severity visualization, risk type visualization, and/or a risk confidence visualization, on the log analysis user interface in response to the detected risk event. Referencing FIG. 57, an example operation 5306 includes an operation 5402 to implement a log analysis user interface, and operation 5702 to provide a risk scope description and/or a risk impact description, on the log analysis user interface in response to the detected risk event. Referencing FIG. 58, an example operation 5306 includes an operation 5402 to implement a log analysis user interface, and operation 5802 to provide a risk scope visualization and/or a risk impact visualization, on the log analysis user interface in response to the detected risk event. Referencing FIG. 59, an example operation 5306 includes providing a notification and/or alert to an external device in response to the detected risk event. Referencing FIG. 60, an example operation 5306 includes an operation 6002 to determine a communication policy update in response to the detected event, and an operation 6004 to communicate the updated communication policy to a log analysis user interface, an external device, and/or the vehicle, in response to the detected risk event. Referencing FIG. 61, an example operation 5306 includes an operation 6102 to determine an automated intrusion response in response to the detected event, and an operation 6104 to communicate the automated intrusion response to a log analysis user interface, an external device, and/or the vehicle, in response to the detected risk event. Referencing FIG. 62, an example operation 5304 includes detecting a signal value in the log corpus.

In some aspects, the techniques described herein relate to a system, including: a vehicle including a plurality of network zones, each network zone including a plurality of end points; a controller, including: a network monitoring component configured to interpret network communications associated with at least one of the network zones; a network intrusion detection component configured to detect an intrusion event in response to the network communications; and an intrusion response component configured to perform an intrusion response operation in response to the detected intrusion event.

In some aspects, the techniques described herein relate to a system, wherein the plurality of network zones include a plurality of ethernet based network zones.

In some aspects, the techniques described herein relate to a system, wherein a first one of the plurality of network zones includes an ethernet based network zone, and wherein a second one of the plurality of network zones includes a controller area network (CAN) based network zone.

In some aspects, the techniques described herein relate to a system, wherein the network intrusion detection component is further configured to detect the intrusion event in response to a communication source value.

In some aspects, the techniques described herein relate to a system, wherein the network intrusion detection component is further configured to detect the intrusion event in response to a communication frequency description.

In some aspects, the techniques described herein relate to a system, wherein the network intrusion detection component is further configured to detect the intrusion event in response to a communication destination value.

In some aspects, the techniques described herein relate to a system, wherein the network intrusion detection component is further configured to detect the intrusion event in response to a communication payload value.

In some aspects, the techniques described herein relate to a system, wherein the intrusion response operation includes providing a notification in response to the detected intrusion event.

In some aspects, the techniques described herein relate to a system, wherein the intrusion response component is further configured to provide the notification in response to a severity of the detected intrusion event.

In some aspects, the techniques described herein relate to a system, wherein the notification is provided to at least one of: an end point on at least one of the network zones; a cloud server; or an external device.

In some aspects, the techniques described herein relate to a system, wherein the notification includes at least one of: a severity description, an intrusion type, an intrusion confidence value, an intrusion destination value, or an intrusion source value.

In some aspects, the techniques described herein relate to a system, wherein the intrusion response operation includes blocking a communication source in response to the detected intrusion event.

In some aspects, the techniques described herein relate to a system, further including: wherein blocking the communication source includes communicating an intrusion source value to a vehicle cloud communication controller; and wherein the controller further includes the vehicle cloud communication controller, the vehicle cloud communication controller configured to manage external communications including communications between: 1) each one of the plurality of end points on the plurality of network zones, and 2) external devices at least selectively communicatively coupled to the vehicle.

In some aspects, the techniques described herein relate to a system, further including: wherein the controller further includes a vehicle cloud communication controller, the vehicle cloud communication controller configured to manage external communications including communications between: 1) each one of the plurality of end points on the plurality of network zones, and 2) external devices at least selectively communicatively coupled to the vehicle; and wherein the intrusion response operation includes providing a notification to the vehicle cloud communication controller.

In some aspects, the techniques described herein relate to a system, further including: wherein the controller further includes a vehicle cloud communication controller, the vehicle cloud communication controller configured to manage communications between: 1) each one of the plurality of end points on the plurality of network zones, and 2) external devices at least selectively communicatively coupled to the vehicle; wherein the vehicle cloud communication controller is further configured to interpret a communication policy; and wherein the network monitoring component is further configured to interpret network communications associated with at least one of the network zones in response to the communication policy.

In some aspects, the techniques described herein relate to a system, further including: wherein the controller further includes a vehicle cloud communication controller, the vehicle cloud communication controller configured to manage communications between: 1) each one of the plurality of end points on the plurality of network zones, and 2) external devices at least selectively communicatively coupled to the vehicle; wherein the vehicle cloud communication controller is further configured to interpret a communication policy; and wherein the network intrusion detection component is further configured to detect an intrusion event in response to the communication policy.

In some aspects, the techniques described herein relate to a system, further including: wherein the controller further includes a vehicle cloud communication controller, the vehicle cloud communication controller configured to manage communications between: 1) each one of the plurality of end points on the plurality of network zones, and 2) external devices at least selectively communicatively coupled to the vehicle; wherein the vehicle cloud communication controller is further configured to interpret a communication policy; and wherein the intrusion response component is further configured to perform the intrusion response operation in response to the communication policy.

In some aspects, the techniques described herein relate to a system, further including: wherein the controller further includes a vehicle cloud communication controller, the vehicle cloud communication controller configured to manage communications between: 1) each one of the plurality of end points on the plurality of network zones, and 2) external devices at least selectively communicatively coupled to the vehicle; wherein the vehicle cloud communication controller is further configured to interpret a communication policy; and the system further including at least one of: wherein the network monitoring component is further configured to interpret network communications associated with at least one of the network zones in response to the communication policy; wherein the network intrusion detection component is further configured to detect an intrusion event in response to the communication policy; or wherein the intrusion response component is further configured to perform the intrusion response operation in response to the communication policy.

In some aspects, the techniques described herein relate to a system, wherein the vehicle cloud communication controller is further configured to interpret at least one of a new communication policy or an updated communication policy, and to update the communication policy in response to the at least one of the new communication policy or the updated communication policy.

In some aspects, the techniques described herein relate to a system, wherein the intrusion response operation includes an update to the communication policy.

In some aspects, the techniques described herein relate to a system, including: a controller, including: an intrusion monitoring component configured to interpret intrusion communications from a plurality of vehicles, each one of the vehicles at least selectively communicatively coupled to the controller, and each one of the vehicles having a plurality of network zones each having a plurality of end points; an intrusion processing component configured to identify an intrusion risk in response to the intrusion communications; and an intrusion reporting component configured to provide an intrusion overview communication in response to the intrusion risk.

In some aspects, the techniques described herein relate to a system, wherein the intrusion reporting component is further configured to provide the intrusion overview communication by providing an intrusion report to an intrusion management user interface.

In some aspects, the techniques described herein relate to a system, wherein the intrusion report includes at least one of: an intrusion severity value, an intrusion scope value, an intrusion confidence value, an intrusion type value, or an intrusion impact description.

In some aspects, the techniques described herein relate to a system, wherein providing the intrusion report includes providing an intrusion management dashboard to the intrusion management user interface.

In some aspects, the techniques described herein relate to a system, wherein the intrusion management dashboard includes at least one of: an intrusion severity visualization, an intrusion scope visualization, an intrusion confidence visualization, an intrusion type visualization, or an intrusion impact visualization.

In some aspects, the techniques described herein relate to a system, wherein the intrusion management dashboard includes a group alert description.

In some aspects, the techniques described herein relate to a system, wherein the intrusion management dashboard includes at least one of a sorting or filtering interface.

In some aspects, the techniques described herein relate to a system, wherein the intrusion management dashboard includes a Pareto analysis interface.

In some aspects, the techniques described herein relate to a system, wherein the intrusion management user interface further includes a security command center interface.

In some aspects, the techniques described herein relate to a system, wherein the intrusion reporting component is further configured to perform, in response to user interactions with the security command center interface, at least one operation selected from the operations consisting of: adjusting a blocked/allowed source list; adjusting a blocked/allowed target list; adjusting a group alert description; performing an escalation operation; or providing interactive data in response to a selection of an element of the intrusion overview communication.

In some aspects, the techniques described herein relate to a system, wherein the intrusion communications include at least one intrusion alert from one of the plurality of vehicles.

In some aspects, the techniques described herein relate to a system, wherein the intrusion processing component is further configured to identify the intrusion risk by analyzing the intrusion communications, and detecting an intrusion event in response to the analysis.

In some aspects, the techniques described herein relate to a system, wherein the intrusion processing component is further configured to detect the intrusion event in response to the analysis of intrusion communications from a plurality of the vehicles.

In some aspects, the techniques described herein relate to a system, wherein the analysis of intrusion communications includes performing a pattern recognition operation.

In some aspects, the techniques described herein relate to a system, wherein the analysis of intrusion communications includes performing a communication source analysis.

In some aspects, the techniques described herein relate to a system, wherein the analysis of intrusion communications includes performing a communication target analysis.

In some aspects, the techniques described herein relate to a system, wherein the analysis of intrusion communications includes performing a communication frequency analysis.

In some aspects, the techniques described herein relate to a system, wherein the analysis of intrusion communications includes performing a communication content analysis.

In some aspects, the techniques described herein relate to a system, including: a vehicle including a plurality of network zones, each network zone including a plurality of end points; a controller, including: a network monitoring component configured to interpret network communications associated with at least one of the network zones; a network intrusion detection component configured to detect an intrusion attempt in response to the network communications; and an intrusion response component configured to perform an intrusion prevention operation in response to the detected intrusion attempt.

In some aspects, the techniques described herein relate to a system, wherein the intrusion prevention operation includes adjusting a blocked/allowed source list.

In some aspects, the techniques described herein relate to a system, wherein the intrusion prevention operation includes adjusting a blocked/allowed target list.

In some aspects, the techniques described herein relate to a system, wherein the network intrusion detection component is further configured to interpret an automated intrusion response in response to the detected intrusion attempt, and to update the operations to detect the intrusion attempt in response to the automated intrusion response.

In some aspects, the techniques described herein relate to a system, wherein the network intrusion response component is further configured to interpret an automated intrusion response in response to the detected intrusion attempt, and wherein the intrusion response component is further configured to update the intrusion prevention operation in response to the automated intrusion response.

In some aspects, the techniques described herein relate to a system, wherein the intrusion response component is further configured to interpret an automated intrusion response in response to the detected intrusion attempt, and to update the operations to respond to the detected intrusion attempt in response to the automated intrusion response.

In some aspects, the techniques described herein relate to a system, further including: wherein the controller further includes a vehicle cloud communication controller, the vehicle cloud communication controller configured to manage communications between: 1) each one of the plurality of end points on the plurality of network zones, and 2) external devices at least selectively communicatively coupled to the vehicle; wherein the vehicle cloud communication controller is further configured to interpret an automated intrusion response; and the system further including at least one of: wherein the network intrusion detection component is further configured to update the operations to detect the intrusion attempt in response to the automated intrusion response; or wherein the intrusion response component is further configured to update the operations to respond to the detected intrusion attempt in response to the automated intrusion response.

In some aspects, the techniques described herein relate to a system, wherein the automated intrusion response includes a workflow to be performed on the controller.

In some aspects, the techniques described herein relate to a system, wherein the workflow includes a workflow to perform at least one operation selected from: detecting an intrusion attempt; confirming an intrusion attempt; adjusting an intrusion notification scheme; blocking an intrusion attempt; or characterizing an intrusion attempt.

In some aspects, the techniques described herein relate to a system, wherein the automated intrusion response is received from an external device.

In some aspects, the techniques described herein relate to a system, wherein the automated intrusion response is at least one of received from the intrusion response component or activated by the intrusion response component.

In some aspects, the techniques described herein relate to a system, including: a controller, including: an intrusion monitoring component configured to interpret intrusion communications from a plurality of vehicles, each one of the vehicles at least selectively communicatively coupled to the controller, and each one of the vehicles having a plurality of network zones each having a plurality of end points; an intrusion processing component configured to identify an intrusion attempt in response to the intrusion communications; and an intrusion prevention component configured to provide at least one of an automated intrusion response or a communication policy, to at least one of the plurality of vehicles, in response to the identified intrusion attempt.

In some aspects, the techniques described herein relate to a system, wherein the intrusion prevention component is further configured to implement an intrusion management user interface, and to provide the at least one of the automated intrusion response or the communication policy in response to user interactions with the intrusion management user interface.

In some aspects, the techniques described herein relate to a system, wherein the automated intrusion response includes a workflow operable on at least one of the plurality of vehicles to perform operations for at least one of: detecting an intrusion attempt; confirming an intrusion attempt; adjusting an intrusion notification scheme; or characterizing an intrusion attempt.

In some aspects, the techniques described herein relate to a system, wherein the automated intrusion response includes a workflow operable on at least one of the plurality of vehicles to perform operations for at least one of: preventing an intrusion; or mitigating an intrusion.

In some aspects, the techniques described herein relate to a system, wherein the communication policy includes at least one of a new communication policy or an updated communication policy.

In some aspects, the techniques described herein relate to a system, wherein the communication policy includes at least one of: a blocked/allowed source value; a blocked/allowed target value; a communication frequency description; or a communication payload value.

In some aspects, the techniques described herein relate to a system, wherein the at least one of the plurality of vehicles includes a first vehicle, and wherein the identified intrusion attempt is associated with a second vehicle of the plurality of vehicles.

In some aspects, the techniques described herein relate to a system, wherein the intrusion processing component is further configured to identify the intrusion attempt based on intrusion communications from a plurality of the plurality of vehicles.

In some aspects, the techniques described herein relate to a system, wherein the intrusion processing component is further configured to identify the intrusion attempt by performing at least one operation selected from: aggregating at least one aspect of the intrusion communications; performing a statistical analysis of at least one aspect of the intrusion communications; or performing a pattern recognition operation of at least one aspect of the intrusion communications.

In some aspects, the techniques described herein relate to a system, wherein each of the intrusion communications includes at least one parameter selected from the parameters consisting of: an intrusion notification value; an intrusion alert value; a network communication value; a network monitoring value; or a control parameter.

In some aspects, the techniques described herein relate to a system, wherein each of the intrusion communications includes at least one parameter selected from the parameters consisting of: an intrusion notification value; an intrusion alert value; a network communication value; a network monitoring value; or a control parameter.

In some aspects, the techniques described herein relate to a system, including: a vehicle including a plurality of network zones, each network zone including a plurality of end points; a controller, including: a log monitoring component configured to interpret a log corpus associated with at least one of the plurality of end points; a log analysis component configured to detect a risk event in response to the log corpus; and a risk response component configured to perform a risk response operation in response to the detected risk event.

In some aspects, the techniques described herein relate to a system, wherein the log corpus is associated with a plurality of the plurality of end points.

In some aspects, the techniques described herein relate to a system, wherein the plurality of the plurality of end points includes a first end point on a first network zone, and a second end point on a second zone.

In some aspects, the techniques described herein relate to a system, wherein the log corpus includes a first log data associated with the first end point, and a second log data associated with the second end point.

In some aspects, the techniques described herein relate to a system, wherein the log corpus includes a combined log data for both the first end point and the second end point.

In some aspects, the techniques described herein relate to a system, wherein the log corpus includes a combined log data for a plurality of the plurality of end points.

In some aspects, the techniques described herein relate to a system, wherein the risk response component is further configured to perform the risk operation by implementing a log analysis user interface in response to the detected risk event.

In some aspects, the techniques described herein relate to a system, wherein the risk response component is further configured to perform at least one of: providing a visualization on the log analysis user interface in response to the detected risk event; providing a notification on the log analysis user interface in response to the detected risk event; providing a risk analysis interface on the log analysis user interface in response to the detected risk event; or providing a suggested action executable object on the log analysis user interface in response to the detected risk event.

In some aspects, the techniques described herein relate to a system, wherein the risk response component is further configured to perform at least one of: providing a risk severity description on the log analysis user interface in response to the detected risk event; providing a risk type description on the log analysis user interface in response to the detected risk event; or providing a risk confidence description on the log analysis user interface in response to the detected risk event.

In some aspects, the techniques described herein relate to a system, wherein the risk response component is further configured to perform at least one of: providing a risk severity visualization on the log analysis user interface in response to the detected risk event; providing a risk type visualization on the log analysis user interface in response to the detected risk event; or providing a risk confidence visualization on the log analysis user interface in response to the detected risk event.

In some aspects, the techniques described herein relate to a system, wherein the risk response component is further configured to perform at least one of: providing a risk scope description on the log analysis user interface in response to the detected risk event; or providing a risk impact description on the log analysis user interface in response to the detected risk event.

In some aspects, the techniques described herein relate to a system, wherein the risk response component is further configured to perform at least one of: providing a risk scope visualization on the log analysis user interface in response to the detected risk event; or providing a risk impact visualization on the log analysis user interface in response to the detected risk event.

In some aspects, the techniques described herein relate to a system, wherein the log corpus is stored on a cloud server at least selectively communicatively coupled to the vehicle.

In some aspects, the techniques described herein relate to a system, wherein the log corpus is stored, at least in part, on a memory positioned on an end point of the vehicle.

In some aspects, the techniques described herein relate to a system, wherein the log corpus includes at least one parameter selected from: a network monitoring parameter; a network communication; a fault code; a fault processing value; a flow monitoring parameter; a flow processing parameter; an electronic control unit (ECU) status value; an event detection value; an operating condition value; a data string value; or metadata associated with any one or more of the foregoing.

In some aspects, the techniques described herein relate to a system, wherein the risk event includes at least one of a security event, a hazard event, a service event, or a mission event.

In some aspects, the techniques described herein relate to a system, wherein the risk response component is further configured to perform the risk response operation by providing a notification to an external device.

In some aspects, the techniques described herein relate to a system, wherein the risk response component is further configured to perform the risk response operation by providing an alert to an external device.

In some aspects, the techniques described herein relate to a system, wherein the risk response component is further configured to perform the risk response operation by determining a communication policy update in response to the detected risk event, and communicating the communication policy update to at least one of: a log analysis user interface; an external device; or the vehicle.

In some aspects, the techniques described herein relate to a system, wherein the risk response component is further configured to perform the risk response operation by determining an automated intrusion response in response to the detected risk event, and communicating the automated intrusion response to at least one of: a log analysis user interface; an external device; or a second vehicle distinct from the vehicle.

In some aspects, the techniques described herein relate to a system, wherein the log analysis component is further configured to detect the risk event in response to detecting a signal value in the log corpus.

In some aspects, the techniques described herein relate to a system, further including: wherein the risk response component is further configured to perform the risk operation by: implementing a log analysis user interface in response to the detected risk event; and update the signal value in response to user interactions with the log analysis user interface; and wherein the log analysis component is further configured to utilize the updated signal value to detect subsequent risk events.

In some aspects, the techniques described herein relate to a system, wherein the log analysis component is further configured to detect the risk event in response to detecting a pattern value in the log corpus.

In some aspects, the techniques described herein relate to a system, further including: wherein the risk response component is further configured to perform the risk operation by: implementing a log analysis user interface in response to the detected risk event; and update the pattern value in response to user interactions with the log analysis user interface; and wherein the log analysis component is further configured to utilize the updated pattern value to detect subsequent risk events.

In some aspects, the techniques described herein relate to a system, wherein the log analysis component is further configured to detect the risk event in response to detecting an operational event value in the log corpus.

In some aspects, the techniques described herein relate to a system, further including: wherein the risk response component is further configured to perform the risk operation by: implementing a log analysis user interface in response to the detected risk event; and update the operational event value in response to user interactions with the log analysis user interface; and wherein the log analysis component is further configured to utilize the updated operational event value to detect subsequent risk events.

In some aspects, the techniques described herein relate to a system, wherein the operation event value includes at least one value selected from: a vehicle operating condition; a flow operating condition; an electronic control unit (ECU) operating condition; or a network operating condition.

In some aspects, the techniques described herein relate to a system, wherein the log analysis component is further configured to detect the risk event in response to detecting a message value in the log corpus.

In some aspects, the techniques described herein relate to a system, further including: wherein the risk response component is further configured to perform the risk operation by: implementing a log analysis user interface in response to the detected risk event; and update the message value in response to user interactions with the log analysis user interface; and wherein the log analysis component is further configured to utilize the updated message value to detect subsequent risk events.

In some aspects, the techniques described herein relate to a system, wherein the message value includes at least one value selected from: a message source value; a message content value; a message frequency value; or a message occurrence value.

The methods and systems described herein may be deployed in part or in whole through a machine having a computer, computing device, processor, circuit, and/or server that executes computer readable instructions, program codes, instructions, and/or includes hardware configured to functionally execute one or more operations of the methods and systems herein. The terms computer, computing device, processor, circuit, and/or server, (“computing device”) as utilized herein, should be understood broadly.

An example computing device includes a computer of any type, capable to access instructions stored in communication thereto such as upon a non-transient computer readable medium, whereupon the computer performs operations of the computing device upon executing the instructions. In certain embodiments, such instructions themselves comprise a computing device. Additionally or alternatively, a computing device may be a separate hardware device, one or more computing resources distributed across hardware devices, and/or may include such aspects as logical circuits, embedded circuits, sensors, actuators, input and/or output devices, network and/or communication resources, memory resources of any type, processing resources of any type, and/or hardware devices configured to be responsive to determined conditions to functionally execute one or more operations of systems and methods herein.

Network and/or communication resources include, without limitation, local area network, wide area network, wireless, internet, or any other known communication resources and protocols. Example and non-limiting hardware and/or computing devices include, without limitation, a general-purpose computer, a server, an embedded computer, a mobile device, a virtual machine, and/or an emulated computing device. A computing device may be a distributed resource included as an aspect of several devices, included as an interoperable set of resources to perform described functions of the computing device, such that the distributed resources function together to perform the operations of the computing device. In certain embodiments, each computing device may be on separate hardware, and/or one or more hardware devices may include aspects of more than one computing device, for example as separately executable instructions stored on the device, and/or as logically partitioned aspects of a set of executable instructions, with some aspects comprising a part of one of a first computing device, and some aspects comprising a part of another of the computing devices.

A computing device may be part of a server, client, network infrastructure, mobile computing platform, stationary computing platform, or other computing platform. A processor may be any kind of computational or processing device capable of executing program instructions, codes, binary instructions and the like. The processor may be or include a signal processor, digital processor, embedded processor, microprocessor or any variant such as a co-processor (math co-processor, graphic co-processor, communication co-processor and the like) and the like that may directly or indirectly facilitate execution of program code or program instructions stored thereon. In addition, the processor may enable execution of multiple programs, threads, and codes. The threads may be executed simultaneously to enhance the performance of the processor and to facilitate simultaneous operations of the application. By way of implementation, methods, program codes, program instructions and the like described herein may be implemented in one or more threads. The thread may spawn other threads that may have assigned priorities associated with them; the processor may execute these threads based on priority or any other order based on instructions provided in the program code. The processor may include memory that stores methods, codes, instructions and programs as described herein and elsewhere. The processor may access a storage medium through an interface that may store methods, codes, and instructions as described herein and elsewhere. The storage medium associated with the processor for storing methods, programs, codes, program instructions or other type of instructions capable of being executed by the computing or processing device may include but may not be limited to one or more of a CD-ROM, DVD, memory, hard disk, flash drive, RAM, ROM, cache and the like.

A processor may include one or more cores that may enhance speed and performance of a multiprocessor. In embodiments, the process may be a dual core processor, quad core processors, other chip-level multiprocessor and the like that combine two or more independent cores (called a die).

The methods and systems described herein may be deployed in part or in whole through a machine that executes computer readable instructions on a server, client, firewall, gateway, hub, router, or other such computer and/or networking hardware. The computer readable instructions may be associated with a server that may include a file server, print server, domain server, internet server, intranet server and other variants such as secondary server, host server, distributed server and the like. The server may include one or more of memories, processors, computer readable transitory and/or non-transitory media, storage media, ports (physical and virtual), communication devices, and interfaces capable of accessing other servers, clients, machines, and devices through a wired or a wireless medium, and the like. The methods, programs, or codes as described herein and elsewhere may be executed by the server. In addition, other devices required for execution of methods as described in this application may be considered as a part of the infrastructure associated with the server.

The server may provide an interface to other devices including, without limitation, clients, other servers, printers, database servers, print servers, file servers, communication servers, distributed servers, and the like. Additionally, this coupling and/or connection may facilitate remote execution of instructions across the network. The networking of some or all of these devices may facilitate parallel processing of program code, instructions, and/or programs at one or more locations without deviating from the scope of the disclosure. In addition, all the devices attached to the server through an interface may include at least one storage medium capable of storing methods, program code, instructions, and/or programs. A central repository may provide program instructions to be executed on different devices. In this implementation, the remote repository may act as a storage medium for methods, program code, instructions, and/or programs.

The methods, program code, instructions, and/or programs may be associated with a client that may include a file client, print client, domain client, internet client, intranet client and other variants such as secondary client, host client, distributed client and the like. The client may include one or more of memories, processors, computer readable transitory and/or non-transitory media, storage media, ports (physical and virtual), communication devices, and interfaces capable of accessing other clients, servers, machines, and devices through a wired or a wireless medium, and the like. The methods, program code, instructions, and/or programs as described herein and elsewhere may be executed by the client. In addition, other devices required for execution of methods as described in this application may be considered as a part of the infrastructure associated with the client.

The client may provide an interface to other devices including, without limitation, servers, other clients, printers, database servers, print servers, file servers, communication servers, distributed servers, and the like. Additionally, this coupling and/or connection may facilitate remote execution of methods, program code, instructions, and/or programs across the network. The networking of some or all of these devices may facilitate parallel processing of methods, program code, instructions, and/or programs at one or more locations without deviating from the scope of the disclosure. In addition, all the devices attached to the client through an interface may include at least one storage medium capable of storing methods, program code, instructions, and/or programs. A central repository may provide program instructions to be executed on different devices. In this implementation, the remote repository may act as a storage medium for methods, program code, instructions, and/or programs.

The methods and systems described herein may be deployed in part or in whole through network infrastructures. The network infrastructure may include elements such as computing devices, servers, routers, hubs, firewalls, clients, personal computers, communication devices, routing devices and other active and passive devices, modules, and/or components as known in the art. The computing and/or non-computing device(s) associated with the network infrastructure may include, apart from other components, a storage medium such as flash memory, buffer, stack, RAM, ROM and the like. The methods, program code, instructions, and/or programs described herein and elsewhere may be executed by one or more of the network infrastructural elements.

The methods, program code, instructions, and/or programs described herein and elsewhere may be implemented on a cellular network having multiple cells. The cellular network may either be frequency division multiple access (FDMA) network or code division multiple access (CDMA) network. The cellular network may include mobile devices, cell sites, base stations, repeaters, antennas, towers, and the like.

The methods, program code, instructions, and/or programs described herein and elsewhere may be implemented on or through mobile devices. The mobile devices may include navigation devices, cell phones, mobile phones, mobile personal digital assistants, laptops, palmtops, netbooks, pagers, electronic books readers, music players and the like. These devices may include, apart from other components, a storage medium such as a flash memory, buffer, RAM, ROM and one or more computing devices. The computing devices associated with mobile devices may be enabled to execute methods, program code, instructions, and/or programs stored thereon. Alternatively, the mobile devices may be configured to execute instructions in collaboration with other devices. The mobile devices may communicate with base stations interfaced with servers and configured to execute methods, program code, instructions, and/or programs. The mobile devices may communicate on a peer-to-peer network, mesh network, or other communications network. The methods, program code, instructions, and/or programs may be stored on the storage medium associated with the server and executed by a computing device embedded within the server. The base station may include a computing device and a storage medium. The storage device may store methods, program code, instructions, and/or programs executed by the computing devices associated with the base station.

The methods, program code, instructions, and/or programs may be stored and/or accessed on machine readable transitory and/or non-transitory media that may include: computer components, devices, and recording media that retain digital data used for computing for some interval of time; semiconductor storage known as random access memory (RAM); mass storage typically for more permanent storage, such as optical discs, forms of magnetic storage like hard disks, tapes, drums, cards and other types; processor registers, cache memory, volatile memory, non-volatile memory; optical storage such as CD, DVD; removable media such as flash memory (e.g. USB sticks or keys), floppy disks, magnetic tape, paper tape, punch cards, standalone RAM disks, Zip drives, removable mass storage, off-line, and the like; other computer memory such as dynamic memory, static memory, read/write storage, mutable storage, read only, random access, sequential access, location addressable, file addressable, content addressable, network attached storage, storage area network, bar codes, magnetic ink, and the like.

Certain operations described herein include interpreting, receiving, and/or determining one or more values, parameters, inputs, data, or other information (“receiving data”). Operations to receive data include, without limitation: receiving data via a user input; receiving data over a network of any type; reading a data value from a memory location in communication with the receiving device; utilizing a default value as a received data value; estimating, calculating, or deriving a data value based on other information available to the receiving device; and/or updating any of these in response to a later received data value. In certain embodiments, a data value may be received by a first operation, and later updated by a second operation, as part of the receiving a data value. For example, when communications are down, intermittent, or interrupted, a first receiving operation may be performed, and when communications are restored an updated receiving operation may be performed.

Certain logical groupings of operations herein, for example methods or procedures of the current disclosure, are provided to illustrate aspects of the present disclosure. Operations described herein are schematically described and/or depicted, and operations may be combined, divided, re-ordered, added, or removed in a manner consistent with the disclosure herein. It is understood that the context of an operational description may require an ordering for one or more operations, and/or an order for one or more operations may be explicitly disclosed, but the order of operations should be understood broadly, where any equivalent grouping of operations to provide an equivalent outcome of operations is specifically contemplated herein. For example, if a value is used in one operational step, the determining of the value may be required before that operational step in certain contexts (e.g., where the time delay of data for an operation to achieve a certain effect is important), but may not be required before that operation step in other contexts (e.g. where usage of the value from a previous execution cycle of the operations would be sufficient for those purposes). Accordingly, in certain embodiments an order of operations and grouping of operations as described is explicitly contemplated herein, and in certain embodiments re-ordering, subdivision, and/or different grouping of operations is explicitly contemplated herein.

The methods and systems described herein may transform physical and/or or intangible items from one state to another. The methods and systems described herein may also transform data representing physical and/or intangible items from one state to another.

The methods and/or processes described above, and steps thereof, may be realized in hardware, program code, instructions, and/or programs or any combination of hardware and methods, program code, instructions, and/or programs suitable for a particular application. The hardware may include a dedicated computing device or specific computing device, a particular aspect or component of a specific computing device, and/or an arrangement of hardware components and/or logical circuits to perform one or more of the operations of a method and/or system. The processes may be realized in one or more microprocessors, microcontrollers, embedded microcontrollers, programmable digital signal processors or other programmable device, along with internal and/or external memory. The processes may also, or instead, be embodied in an application specific integrated circuit, a programmable gate array, programmable array logic, or any other device or combination of devices that may be configured to process electronic signals. It will further be appreciated that one or more of the processes may be realized as a computer executable code capable of being executed on a machine readable medium.

The computer executable code may be created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and computer readable instructions, or any other machine capable of executing program instructions.

Thus, in one aspect, each method described above, and combinations thereof, may be embodied in computer executable code that, when executing on one or more computing devices, performs the steps thereof. In another aspect, the methods may be embodied in systems that perform the steps thereof, and may be distributed across devices in a number of ways, or all of the functionality may be integrated into a dedicated, standalone device or other hardware. In another aspect, the means for performing the steps associated with the processes described above may include any of the hardware and/or computer readable instructions described above. All such permutations and combinations are intended to fall within the scope of the present disclosure.

What is claimed is:

1. A system, comprising:
a vehicle comprising a plurality of network zones, each network zone comprising a plurality of end points;
a controller, comprising:
a network monitoring component configured to interpret network communications associated with at least one of the network zones;
a network intrusion detection component configured to detect an intrusion attempt in response to the network communications; and
an intrusion response component configured to perform an intrusion prevention operation in response to the detected intrusion attempt.

2. The system of claim 1, wherein the intrusion prevention operation comprises adjusting a blocked/allowed source list.

3. The system of claim 1, wherein the intrusion prevention operation comprises adjusting a blocked/allowed target list.

4. The system of claim 1, wherein the network intrusion detection component is further configured to interpret an automated intrusion response in response to the detected intrusion attempt, and to update the operations to detect the intrusion attempt in response to the automated intrusion response.

5. The system of claim 1, wherein the network intrusion response component is further configured to interpret an automated intrusion response in response to the detected intrusion attempt, and wherein the intrusion response component is further configured to update the intrusion prevention operation in response to the automated intrusion response.

6. The system of claim 1, wherein the intrusion response component is further configured to interpret an automated intrusion response in response to the detected intrusion attempt, and to update the operations to respond to the detected intrusion attempt in response to the automated intrusion response.

7. The system of claim 1, further comprising:
wherein the controller further comprises a vehicle cloud communication controller, the vehicle cloud communication controller configured to manage communications between: 1) each one of the plurality of end points on the plurality of network zones, and 2) external devices at least selectively communicatively coupled to the vehicle;
wherein the vehicle cloud communication controller is further configured to interpret an automated intrusion response; and
the system further comprising at least one of:
wherein the network intrusion detection component is further configured to update the operations to detect the intrusion attempt in response to the automated intrusion response; or
wherein the intrusion response component is further configured to update the operations to respond to the detected intrusion attempt in response to the automated intrusion response.

8. The system of claim 7, wherein the automated intrusion response comprises a workflow to be performed on the controller.

9. The system of claim 8, wherein the workflow comprises a workflow to perform at least one operation selected from:
detecting an intrusion attempt;
confirming an intrusion attempt;
adjusting an intrusion notification scheme;
blocking an intrusion attempt; or
characterizing an intrusion attempt.

10. The system of claim 7, wherein the automated intrusion response is received from an external device.

11. The system of claim 7, wherein the automated intrusion response is at least one of received from the intrusion response component or activated by the intrusion response component.
